(19) United States
(12) Patent Application Publication
(10) Pub. No.: US 2003/0018457 A1
(43) Pub. Date: Jan. 23, 2003

(54) Biological modeling utilizing image data

(76) Inventors: Gregory Scott Lett, Hightstown, NJ (US); Dean C. Bottino, Hightstown, NJ (US)

Correspondence Address: PHYSIOME SCIENCES, INC., 150 COLLEGE ROAD WEST, PRINCETON, NJ, 08540, US

(21) Appl. No.: 10/095,175

(22) Filed: Mar. 11, 2002

Related U.S. Application Data
(60) Provisional application No. 60/275,287, filed on Mar. 13, 2001.

(51) Int. Cl. G06G 7/48; G06G 7/58

(52) U.S. Cl. 703/11

(57) ABSTRACT

The present invention relates to a method and system for quantitative and semi-quantitative modeling of biological and physiological systems using image data. More specifically, the system utilizes time-series image data to improve the accuracy of the predictions made by a simulation model capable of forecasting the spatiotemporal evolution of a given biological or physiological system. Furthermore, in accordance with another aspect of the invention, the quality of experimentally acquired images can be improved by using a simulation model to eliminate noise and measurement errors from the acquired image data. Finally, in accordance with another aspect of the invention, certain undamped random disturbances in a biological or physiological system can be detected and tracked by applying a fading-memory filter to acquired time-series data and predictions of the time series using a simulation model that takes into account underlying physiological, chemical or biological variables.

### CROSS-REFERENCE TO RELATED APPLICATION

This application claims the benefit of priority of provisional U.S. patent application Ser. No. 60/275,287, filed Mar. 13, 2001, which is incorporated herein by reference.

### BACKGROUND OF THE INVENTION

1. Field of the Invention

The present invention relates to a method and system for quantitative and semi-quantitative modeling of biological systems using image data.

2. Description of the Related Art

Concomitant with recent breakthroughs in bioinformatics and computational biology, there have been significant advances in the development of highly detailed computer simulations of biological or physiological systems. These models can be used to describe and predict the temporal evolution of various biochemical, biophysical and/or physiological variables of interest. These simulation models have great value both for pedagogical purposes (i.e., by contributing to our understanding of the biological systems being simulated) and for drug discovery efforts (i.e., by allowing in silico experiments to be conducted prior to actual in vitro or in vivo experiments).

Concomitant with the aforementioned advances in biological simulation, there have been recent significant advances relating to biological experimental methods that allow researchers to measure the temporal, and often spatiotemporal, progression of the biological/physiological state of intact living cells, tissues, organs, and organisms. The data obtained using these new experimental methods is often presented as a time series of images (e.g., a series of two-dimensional pictures) that depict or represent the temporal evolution of the spatial distribution of the probed molecules or other physiological variables.

Coupling these new data acquisition techniques with detailed computer simulation models should increase the fidelity of the simulation models, thereby allowing for more accurate predictions of the dynamics of the biological/physiological system in question. To date, however, no rigorous method exists to combine predictive biological simulation models with spatiotemporal data. The potential value of such a combination includes the automated fitting of model parameters to the raw image data, enhancement of raw images using predictions generated by the simulation model, and the automated detection of the commitment of a biological system toward an irreversible fate, such as the onset of mitosis.

Existing imaging techniques typically have been used by scientists and researchers to make qualitative assessments about a biological or physiological system based upon two-dimensional (and, in some cases, three-dimensional) pictures generated by the image acquisition method. In some cases, some quantitative analysis has been performed on time-series image data, but the spatiotemporal data has heretofore not been systematically incorporated into a biological or physiological model capable of predicting the dynamic spatial distribution of various biological and physiological variables.

Previous approaches to analyzing time-series image data consisted primarily of (1) converting the acquired image data to a spatial distribution of an underlying variable correlating to the image intensity; (2) applying standard time-series analytical techniques (e.g., ARIMA) directly to the actual image data or some derived quantity; or (3) integrating spatially over some region to obtain a scalar parameter, which may then be “plugged into” a predictive model. In the first case, one merely obtains a static description of the biological or physiological system at a particular point in time (i.e., the instant at which the image was acquired); hence, one is not able to use the acquired image data to predict the evolution of that system or to predict the value of variables other than the “measured” variable correlating to image intensity. For the second approach described above, the “predictive” model does not take into account the underlying biological and physiological variables affecting the system, and hence is not robust. Finally, a drawback of the third approach is that, by integrating spatially, one loses valuable information about the spatial variation in the measured variable, thereby decreasing the fidelity and usefulness of the predictive model.

An example of the first approach is described in C. Fink et al., “Intracellular Fluorescent Probe Concentrations by Confocal Microscopy,” Biophys. J. 75(4): 1648-58 (1998). The article describes how confocal microscopy can be used for: estimation of intracellular concentrations of a fluorescent calcium indicator; estimation of the relative distribution between the neurite and soma of a neuronal cell of the inositol triphosphate (IP3) receptor on the endoplasmic reticulum; estimation of the distribution of the bradykinin receptor along the surface of a neuronal cell; and estimation of the relative distribution of a potentiometric dye between the mitochondria and cytosol as a means of assaying mitochondrial membrane potential. The article also describes how to perform dilution corrections based on the intensity distribution found in a computationally synthesized model for a cell or organelle that has been blurred by convolution with the microscope point spread function. The reference does not, however, teach or suggest how time-series images obtained using confocal microscopy can be used to update or modify a predictive model capable of forecasting the spatiotemporal evolution of the modeled system.

Numerous other fairly sophisticated techniques for dynamic image acquisition and analysis have been developed, but they each suffer from one or more of the abovementioned drawbacks. For example, U.S. Pat. No. 5,655,028 (Dynamic Image Analysis System), which is hereby incorporated by reference, describes a system for tracking deformable moving objects such as crawling amoeboid cells and for acquiring phenomenological parameters that potentially allow for the quantitative analysis of the effects of experimental intervention on cell deformation, motility, and chemotaxis. Another image sequence analysis technique is described in D. Uttenweiler et al., “Motion Determination in Actin Filament Fluorescence Images with a Spatio-Temporal Orientation Analysis Method,” Biophys. J. 78(5): 2709-15 (2000). The described methodology automatically measures the motion in a series of microscopic fluorescence images using a three-dimensional structure tensor technique to calculate the displacement vector field for every image of the sequence (from which velocities are subsequently derived). The method is applied to the analysis of the movement of single actin filaments in an in vitro motility assay, where fluorescently labeled actin filaments move over a myosin-decorated surface. However, neither reference teaches or suggests a method for systematically and automatically modifying a simulation model capable of predicting the spatiotemporal evolution of the system modeled based upon the underlying physiological and/or biological parameters and equations governing the dynamics of that system.

Similarly limited are analytical techniques that enable visualization of underlying biological and physiological variables without the ability to predict the spatiotemporal evolution of those variables. For example, in J. Lee et al., “Traction Forces Generated by Locomoting Keratocytes,” J. Cell Biol. 127: 1957-64 (1994), the researchers describe a method for visualizing the spatiotemporal dynamics of traction forces exerted by crawling cells on a flexible substrate by measuring the direction and magnitude of the two-dimensional displacements of substrate-embedded beads. The traction-force displacement imaging method described by Lee was extended in M. T. Dembo et al., “Imaging the Traction Stresses Exerted by Locomoting Cells with the Elastic Substratum Method,” Biophys. J. 70(4): 2008-22 (1996), which teaches a Bayesian method for converting noisy measurements of substratum displacement into “images” of the actual traction forces exerted by adherent of locomoting cells. Dembo, like Lee, does not teach a method for predicting the spatiotemporal evolution of the system being studied and does not teach how the image data collected can be used to improve the fidelity and accuracy of a predictive model.

Similarly, several papers describe methods for visualizing action potential propagation in the heart by grids of electrodes and by fluorescent voltage-sensitive dyes: S. D. Girouard et al., “Optical Mapping in a New Guinea Pig Model Of Ventricular Tachycardia Reveals Mechanisms for Multiple Wavelengths in a Single Reentrant Circuit,” Circulation 93(3): 603-13 (1996); R. Gray et al., “Nonstationary Vortexlike Reentrant Activity as a Mechanism of Polymorphic Ventricular Tachycardia in the Isolated Rabbit Heart,” Circulation 91(9): 2454-69 (1995); B. Tacardi et al., “Effect of Myocardial Fiber Direction on Epicardial Potentials,” Circulation 90(6): 3076-90 (1994). None of these references teach or suggest a method for modifying or updating a simulation model capable of predicting the spatiotemporal evolution of the modeled system.

Furthermore, most of the current approaches to modeling of biological and physiological systems do not allow for spatial modeling or only incorporate spatial information in a quite limited fashion. Even those biological and physiological simulation systems that are able to take into account spatial and spatiotemporal variables are not capable of automatically and systematically updating or adjusting model parameters based upon time-series image data.

One example of biological simulation software currently available for modeling of biological and physiological systems is DBsolve, which is described in further detail in I. Goryanin et al., “Mathematical Simulation and Analysis of Cellular Metabolism and Regulation,” Boinformatics 15(9): 749-58 (1999). DBsolve is a mathematical simulation workbench, which is capable of performing the following functions: (i) derivation of large-scale mathematical models from metabolic reconstructions and other data sources; (ii) solving and parameter continuation of non-linear algebraic equations, including metabolic control analysis; (iii) solving the non-linear stiff systems of ordinary differential equations; (iv) bifurcation analysis of ordinary differential equations; and (v) parameter fitting to experimental data or functional criteria based on constrained optimization. DBsolve has been used for dynamic metabolic modeling of some typical biochemical networks, including microbial glycolytic pathways, signal transduction pathways and receptor-ligand interactions.

Another example of biological modeling software is GEPASI, a metabolic-pathway-simulation software package that models chemical- and biochemical-reaction networks for any chemical-reaction system of up to 45 metabolites and 45 reactions, using either user-defined or certain predefined rate equations. This software package can be used to forecast the temporal evolution of the various metabolite concentrations or to determine the steady-state solution (if one exists) to the system of equations characterizing the chemical reaction network. When steady-state solutions exist, GEPASI also can calculate elasticity and control coefficients, as defined in metabolic control analysis. Furthermore, GEPASI allows the automatic generation of a sequence of simulations using different combinations of parameter values. GEPASI is described in further detail in a number of publications: P. Mendes & D. Kell, “Non-Linear Optimization Of Biochemical Pathways: Applications to Metabolic Engineering and Parameter Estimation,” Boinformatics 14(10): 869-83 (1998); P. Mendes, “Biochemistry By Numbers: Simulation of Biochemical Pathways with GEPASI 3,” Trends Biochem. Sci. 22(9): 361-63 (1997); P. Mendes & D. B. Kell, “On the Analysis of the Inverse Problem of Metabolic Pathways Using Artificial Neural Networks,” Biosystems 38(1): 15-28 (1996); P. Mendes, “GEPASI: A Software Package for Modeling the Dynamics, Steady States and Control of Biochemical and Other Systems,” Comput. Appl. Biosci. 9(5): 563-71 (1993).

An example of a very sophisticated biological modeling platform is the In Silico Cell™ modeling environment developed by Physiome Sciences, Inc. (Princeton, N.J.). The In Silico Cell™ modeling platform, which allows biological-systems modelers to create computational models of subcellular, cellular and intercellular systems and processes, is described in more detail in U.S. patent application Ser. Nos. 09/295,503 (System and Method for Modeling Genetic, Biochemical, Biophysical and Anatomical Information: In Silico Cell); 09/499,575 (System and Method for Modeling Genetic, Biochemical, Biophysical and Anatomical Information: In Silico Cell); 09/599,128 (Computational System and Method for Modeling Protein Expression); and 09/723,410 (System for Modeling Biological Pathways), which are each hereby incorporated by reference.

There are also a number of simulation applications specific to a particular biological or physiological system. For example, NEURON is a software package designed to model neuronal signal conduction in a single neuron or a network of neurons; this software package is described in more detail in M. Hines, “NEURON: A Program for Simulation of Nerve Equations,” Neural Systems: Analysis and Modeling (F. Eeckman, ed., Kluwer Academic Publishers, 1993). Another neuronal modeling package is GENESIS, a UNIX-based neuroscience simulation package, which is described in detail in J. M. Bower & D. Beeman, The Book of GENESIS: Exploring Realistic Neural Models with the General Neural Simulation System, (2d ed., Springer-Verlag, N.Y., 1998). Both of these packages simplify the underlying equations based upon the symmetry and shape of neurons, and hence cannot be applied generally to other biological or physiological systems without modification.

Numerous other simulation packages have been applied to modeling biological and physiological systems including: Talis (a visual and interactive real-time tool for simulating metabolic pathways, gene circuits and signal transduction pathways); NetWork (a Java applet for interactive simulation of genetic networks); SCAMP (a command-line driven software package running on the Atari ST and MS-DOS operating systems; capable of simulating steady-state and transient behavior of metabolic pathways and calculation of all metabolic control analysis coefficients); MIST (a biological pathway simulation package running on MS Windows 3.1); MetaModel (MS-DOS-based software package for steady-state simulation of metabolic pathways); SCoP (a commercial simulation program that can be used to simulate metabolic systems); CONTROL (a DOS-based software package that uses the Reder matrix method to calculate control coefficients from elasticity values); MetaCon (a DOS-based metabolic control analysis program available at ftp://bmshuxley.brookes.ac.uk/-pub/software/ibmpc/metacon); BioThermo (a simulation package that calculates the feasibility of individual pathway reactions based upon Gibbs free energy values and metabolite concentrations); FluxMap (a simulation package that calculates metabolic fluxes based on metabolite balancing); BioNet (a metabolic flux analysis package); and the Matlab Simulink and Stateflow simulation packages.

Notably, none of the other abovementioned simulation software packages currently has the capability of creating a true spatial model of a biological or physiological system. It is possible to create pseudo-spatial models using some of these simulation packages by designing compartmental models wherein the compartments correspond to some region of physical space in the cell, tissue, organ or organism being modeled (e.g., the cytosol, the cell membrane, an organelle, or a discrete portion of a cell or organelle). Although these pseudo-spatial simulation models are capable of predicting, in a limited fashion, the spatial distribution of underlying biochemical, biological or biophysical components, or the spatiotemporal evolution of such components, no one has heretofore successfully developed a rigorous method for modifying or updating these simulation models automatically based upon experimental time-series image data.

Recently, a number of explicitly “spatial” models of biological or physiological systems have been developed. For example, a computational model for simulating the electrical and chemical dynamics of the heart is described in U.S. Pat. No. 5,947,899 (Computational System and Method for Modeling the Heart), which is hereby incorporated by reference. This computational model combines a detailed, three-dimensional representation of the cardiac anatomy with a system of mathematical equations that describe the spatiotemporal behavior of biophysical quantities, such as voltage at various locations in the heart.

Another biological simulation system that explicitly allows for spatiotemporal modeling is the Virtual Cell, a software package developed at the University of Connecticut. The Virtual Cell and its capabilities is described in some detail in the following references: J. C. Schaff, B. M. Slepchenko, & L. M. Loew, “Physiological Modeling with the Virtual Cell Framework,” in Methods in Enzymology, vol. 321, pp. 1-23 (M. Johnson & L. Brand, eds., Academic Press, 2000); J. Schaff & L. M. Loew, “The Virtual Cell,” Pacific Symposium on Biocomputing 4: 228-39 (1999); and J. Schaff et al., “A General Computational Framework for Modeling Cellular Structure and Function,” Biophys. J. 73(3): 1135-46 (1997).

The Virtual Cell is not a fixed model of a particular cell type or particular biological system, but rather a tool that allows experimental biologists and other bench scientists to develop appropriate simulation models by specifying biologically relevant abstractions such as reactions, cellular compartments, molecular species, and experimental geometry. The Virtual Cell provides a general system for testing cell biological mechanisms and for developing models that take into account the distribution and dynamics of intracellular biochemical processes. The software package creates dynamic “spatial” models by associating biochemical and electrophysiological data describing individual reactions with experimental microscopic image data describing their subcellular localizations.

An illustration of the use of the Virtual Cell for spatiotemporal modeling is described in C. C. Fink et al., “An Image-Based Model of Calcium Waves in Differentiated Neuroblastoma Cells,” Biophys. J. 79: 163-183 (2000), which discloses the results generated from a dynamic simulation of IP3-mediated Ca²⁺ release from endoplasmic reticulum in a neuronal cell, and then compares the simulation results with experimental observations of the simulated system. The reference does not, however, teach how a series of experimentally observed images can be used to modify the predictive model in order to generate more accurate forecasts.

Another example of a spatiotemporal model is described in D. Uttenweiler et al., “Mathematical Modeling and Fluorescence Imaging to Study the Ca²⁺ Turnover in Skinned Muscle Fibers,” Biophys. J. 74(4): 1640-53 (1998). The article presents a mathematical model that simulates the spatial and temporal time course of Ca²⁺ ion movement in caffeine-induced calcium transients of chemically skinned muscle fiber preparations. The model described in this reference assumes cylindrical symmetry and quantifies the radial profile of Ca²⁺ ion concentration by solving the diffusion equations for Ca²⁺ ions and various mobile buffers, and the rate equations for Ca²⁺ buffering (mobile and immobile buffers) and for the release and reuptake of Ca²⁺ ions by the sarcoplasmic reticulum (SR), with a finite-difference algorithm. Although the results of the model were compared with caffeine-induced spatial Ca²⁺ transients obtained from saponin skinned murine fast-twitch fibers by fluorescence photometry and imaging measurements using the ratiometric dye Fura-2, the reference does not teach how experimental fluorescence images can be used to calibrate the mathematical model and improve the model's predictive accuracy.

Another example of a spatiotemporal simulation system is disclosed in U.S. Pat. No. 5,930,154 (Computer-Based System and Methods for Information Storage, Modeling and Simulation of Complex Systems Organized in Discrete Compartments in Time and Space), which is hereby incorporated by reference. This patent discloses a computer-based system for developing visual models of complex systems organized in discrete time and space compartments, as well as a method for dynamically simulating that system, using quantitative and semi-quantitative simulation methods. Notably, this patent does not teach or suggest how time-series image data can be used to modify the underlying simulation model to achieve more accurate predictions of the system being modeled.

### SUMMARY OF THE INVENTION

One object of the invention is to provide a method and system for systematically incorporating image data into a biological or physiological simulation model. Another object of the invention is to provide a method and system for analyzing spatiotemporal data. Yet another object of the invention is to provide a system and method for improving the accuracy and reliability of the predictions made by a simulation model based upon acquired time-series image data. In addition, another object of the invention is to provide a system and method for eliminating noise and measurement errors in acquired image data using predictions made by a simulation model. Finally, another object of the invention is to provide a system and method for detecting and tracking certain undamped random disturbances in a biological or physiological system.

Accordingly, there is provided a method and system for quantitative or semi-quantitative modeling of a biological or physiological system, said method comprising the steps of: acquiring time-series image data relating to said biological or physiological system; generating a prediction of the dynamic evolution of the state of said biological or physiological system using a simulation model that takes into account underlying physiological, chemical or biological variables; converting said biological- or physiological-state prediction into a series of predicted images corresponding temporally to the acquired images; and adjusting one or more parameters of the simulation model in order to reduce the magnitude of an error measure based upon the differences between the acquired time-series image data and the predicted images. The comparison between the acquired data and the predicted data need not be made in image space, and can alternatively be made in the model state space or a space resulting from a suitable transformation from the state space or image space.

In accordance with another aspect of the invention, there is provided a method and system for improving the quality of spatiotemporal data relating to a biological or physiological system, comprising the steps of: acquiring time-series image data relating to said biological or physiological system; generating a prediction of the dynamic evolution of the state of said biological or physiological system using a simulation model that takes into account underlying physiological, chemical or biological variables; and correcting the acquired images to eliminate noise and measurement errors based upon the predictions of said simulation model.

Finally, there is also provided a method and system for detecting and tracking undamped random disturbances in a biological or physiological system, comprising the steps of: acquiring time-series data relating to said biological or physiological system; generating a prediction of the dynamic evolution of the state of said biological or physiological system using a simulation model that takes into account underlying physiological, chemical or biological variables; and applying a recursive fading-memory filter to determine the onset of a significant alteration of the state trajectory resulting from a robustly and persistently amplified random disturbance to the system.

Further objects, features, aspects and advantages of the present invention will become apparent from the drawings and description contained herein.

### BRIEF DESCRIPTION OF THE DRAWINGS

The invention will be more fully understood and further advantages will become apparent when reference is made to the following detailed description and the accompanying drawings in which:

FIG. 1 is a diagram depicting some of the hardware components of one embodiment of the invention; and

FIG. 2 is a flow chart of the process steps in one embodiment of the invention.

FIGS. 3 and 4 are graphs of parameter-estimation runs using a modified EKF protocol on simulated data generated using a modified Hodgkin-Huxley model of a calcium current in pituitary corticotroph cells.

### DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

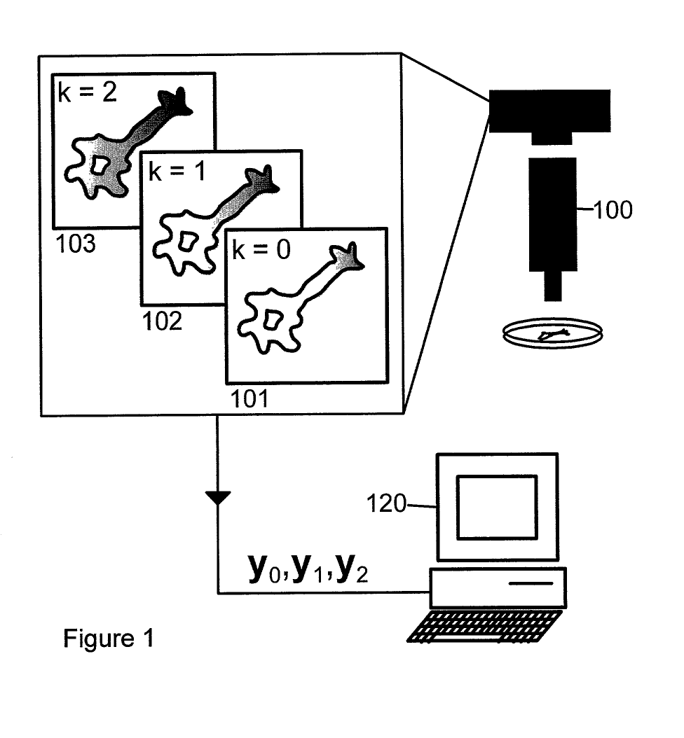

Referring to FIG. 1, the image acquisition system 100 is capable of acquiring a series of images 101 through 103. Preferably, the images are two-dimensional images relating to the biological or physiological system of interest, although it is certainly possible to apply the present invention to one-dimensional or three-dimensional “image” data. As more fully described below, any of a number of image acquisition devices or technologies may be used without departing from the scope of the invention. The appropriate image acquisition technology will depend upon what biological or physiological variables are to be measured, and the degree of accuracy/precision required. The selection of the appropriate image acquisition technology is well within the skill of the ordinary artisan.

In a preferred embodiment, the acquired images each correspond to a different time point. For example, in FIG. 1, image 101 depicts a picture of a neuroblastoma cell at some initial time t₀. Image 102 shows a picture of the same cell at a later point in time, after the labeled probe has diffused toward the center of the cell; and image 103 depicts the neuroblastoma cell at yet a later point in time, after the labeled probe has further diffused throughout the cell. Preferably, the images are acquired at evenly spaced time intervals. However, it is possible to use image data acquired at irregular time intervals or even to use multiple images acquired at a single point in time without departing from the scope of the invention.

As depicted in FIG. 1, the acquired image data is transmitted to a computer 120. In a preferred embodiment, the computer 120 is a general-purpose computer comprised of a central processing unit (CPU), a user interface, and memory (including both primary random access memory (RAM) and nonvolatile secondary memory, such as optical disk storage or magnetic tape). The image acquisition system 100 may have its own CPU, memory and user interface for controlling the acquisition, storage and processing of images. In a preferred embodiment, the computer 120 also controls the operations of the image acquisition system 100. The computer 120 may be remotely located and accessed over the internet or an intranet. Alternatively, the computer 120 may be physically integrated with the image acquisition system 100 or with portions of the image acquisition system 100.

The acquired image data may be raw experimental data or processed or transformed image data (e.g., correction for background noise and “outlier” data points, correction for artifacts of the data acquisition process or device, normalized to some scale, transformed to a different coordinate system). For example, the raw image intensity levels may be subjected to first-order differencing (i.e., subtract the image intensity of a particular pixel at time tₖ₋₁ from the intensity at time tₖ). In addition, a log transformation can be performed on the differenced data in order to reduce the effect of outliers.

Various pre-processing techniques applied to the raw images can reduce the “noisiness” of the data and improve the quality of the images. An example of such a “pre-processing” technique is the anisotropic diffusion filtering method developed by Dietmar Uttenweiler for increasing the signal-to-noise (S/N) ratio in noisy fluorescence images; this method is of particular value when quantitatively measuring motion in low light level fluorescence image sequences of cellular and subcellular motion processes. As described more fully in D. C. Uttenweiler et al., “Motion Determination in Actin Filament Fluorescence Images with a Spatio-Temporal Orientation Analysis Method,” Biophys. J. 78(5): 2709-15 (2000), this approach has been applied to fluorescence image sequences of in vitro motility assay data, where fluorescently labeled actin filaments move over an immobilized-myosin surface.

The acquired image data may be stored in any known image format (e.g., JPEG, bitmap, PNG) and may be transmitted in accordance with any established protocol for data transmission. The choice and implementation of the appropriate format and transmission protocol are within the skill of the ordinary artisan.

In a preferred embodiment, an image is stored as a sequence of digital values that represents the spatial distribution of one or more quantities of interest. Images may be stored in any of a number of formats, representing vector or raster graphics or multispectral data, and may or may not be in a compressed format; preferably, the images are stored in an uncompressed format. Examples of standard general-purpose image file formats suitable for use in a preferred embodiment include BMP, JPEG, PNG and SVG; proprietary formats and standards relating to biological or medical imaging, such as DICOM, would also serve equally well. Furthermore, any general-purpose file or database format (such as NetCDF) may also be used.

A simulation model capable of predicting the spatiotemporal evolution of the biological or physiological system in question is then run on the computer 100. In a preferred embodiment, the simulation model can be run simultaneously on multiple processors, thereby increasing the efficiency and speed of the computation. Preferably, the simulation model is highly detailed and robust over all ranges of the conditions and variables of interest. However, even a low-fidelity model would benefit from application of the invention, which allows any biological or physiological simulation model to be improved or fine-tuned using acquired image data. Moreover, in certain instances, the quality of the acquired image can be improved using information from the simulation model even where the model is not a high-fidelity model.

The simulation results are then converted to time-series images corresponding to the acquired images. This mapping of the state space to a series of predicted images requires a model of how the image data relates to one or more underlying biochemical, physiological, biophysical or biological variables, as well as a model of the image compression algorithm used, if any. This “image generation” model should include a component that estimates or otherwise takes into account the effects of random sources of error (e.g., noise introduced by the image acquisition device), which may alter the image.

Finally, the predicted images are compared with the acquired images, and the simulation model is modified in such a manner as to improve the “goodness of fit” between the predicted images and the acquired images. The comparison may be performed in image space (i.e., directly comparing the numerical value of the intensity of each pixel of the predicted and acquired images) or in some other data space that maps in some way to image space. For example, the image data can be converted into the value of some temporally and spatially varying variable (e.g., concentration of a protein or other substance at different locations in the cytosol) and compared with predicted values of that variable. Alternatively, the raw images can be processed using some analytical technique to extract or derive the value of some property that varies spatially and temporally. See, for example, U.S. Pat. No. 5,655,028 (Dynamic Image Analysis System), and R. E. Pagano et al., “Use of N-[5-(5,7-Dimethyl Boron Dipyrromethene Difluoride-Sphingomyelin to Study Membrane Traffic Along the Endocytic Pathway,” Chem. Phys. Lipids 102: 55-63 (1999). The derived property value can then be compared with the property value predicted by the simulation model. Finally, one may perform an ensemble of Monte Carlo simulations of the system being studied, and then compare the statistics thereby generated with the corresponding experimental statistics calculated from the acquired image data.

In order to adjust the simulation model to improve the “goodness of fit,” one may explicitly specify and calculate an error measure that correlates with the difference between the predicted and acquired images, and then modify the simulation model (either by adjusting model parameters or by structurally changing the simulation model) until that error measure is minimized or at least reduced. Alternatively, one may use a model calibration method that inherently reduces or minimizes an implicit error measure—without necessarily calculating the value of the error measure.

The model adjustment step can be accomplished in a number of ways. There is, of course, the naive “brute force” method of iteratively stepping through every possible combination of parameter values, and determining which combination minimizes the error measure. More sophisticated approaches include using neural nets, simulated annealing and other machine learning algorithms to adjust the model parameters. The model adjustment step can consist merely of parameter estimation based upon the acquired image data, or can comprise choosing among a set of competing models that are structurally and mechanistically distinct. The selection and implementation of an appropriate model adjustment method is within the skill of the ordinary artisan.

A preferred method for adjusting the model comprises applying a batch estimator or recursive filter, as described more fully below. Numerous batch estimators and recursive filters are well known in the art. Examples of batch estimators include the Levenberg-Marquardt method, the Nelder-Meade method, the steepest descent method, Newton's method, and the inverse Hessian method. Examples of recursive filters include the least-squares filter, the pseudo-inverse filter, the square-root filter, the Kalman filter and Jazwinski's adaptive filter. Preferred for applications wherein random events during an experiment perturb the state and the subsequent course of the experiment in a significant way are fading-memory filters, such as the Kalman filter, which remain sensitive to new data. Most preferred for certain applications are extensions/variants of the Kalman filter, such as the Extended Kalman Filter (EKF), the unscented Kalman Filter (UKF) and Jazwinski's adaptive filter (as described more fully in A. H. Jazwinski, Stochastic Processes And Filtering Theory (Academic Press, New York, 1970)); these filters can combine computational efficiency, robustness and the fading-memory characteristics discussed above. When the actual error distributions do not fit the assumptions underlying these filters, other estimators, such as the Particle Filter (PF) and other sequential Monte Carlo estimators can be used.

Image Data Acquisition

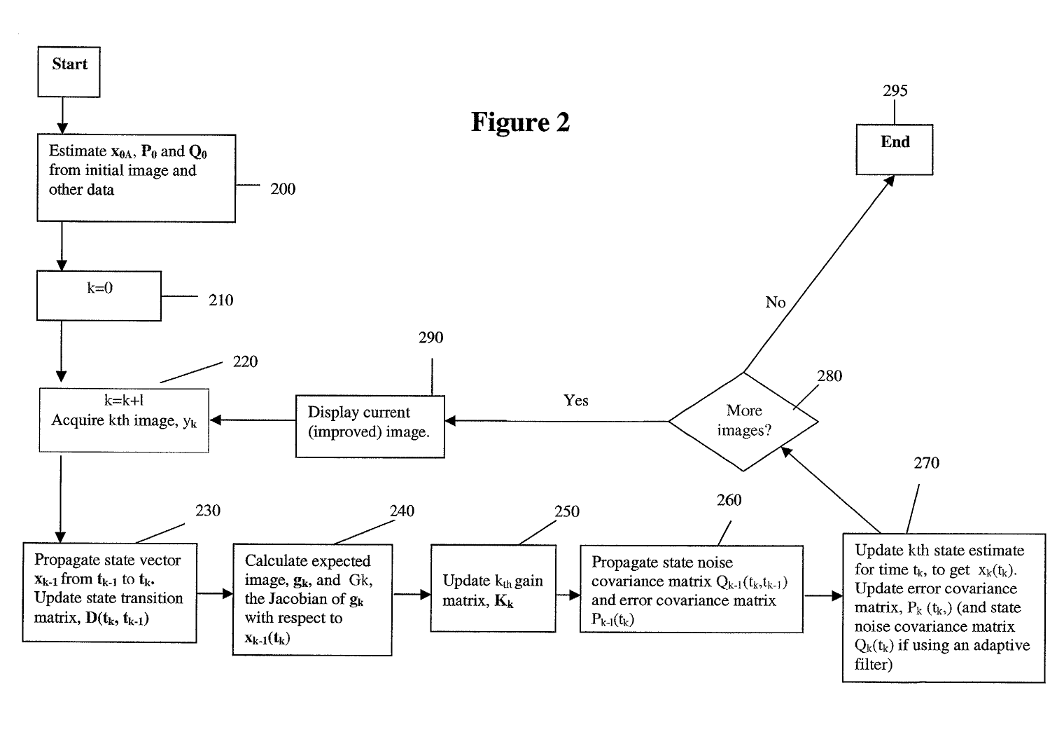

Referring to FIG. 2, the first acquired image, as well as other data, is used to determine the a priori initial state of the biological or physiological system being modeled x_{0A} (step 200). In addition, the initial state noise covariance matrix Q₀ and the initial error covariance matrix P₀ are estimated based upon the initial image and other data relating to the initial conditions of the system (step 200).

The image acquisition step 220 is repeated at discrete time intervals. The acquired image data, represented as a vector yₖ, is used to improve the estimate of the next state of the system, represented as a vector xₖ, stored as an array containing the values of each of the state variables at time tₖ (as shown in step 230).

Numerous image data acquisition methods are well known in the art and can be used to obtain image data for purposes of this invention. Examples of well known imaging techniques include: electron microscopy; video microscopy (e.g., using a cooled CCD camera); confocal microscopy and confocal ratio imaging; digital imaging microscopy; optical force microscopy; atomic force microscopy; VE-DIC light microscopy and other forms of light/optical microscopy; and EPR spectroscopy.

The above-listed imaging techniques, as well as numerous others, are described and taught in various references, which are familiar to those skilled in the art. For example, G. Sluder & D. E. Wolf, Methods in Cell Biology: Video Microscopy (Academic Press, 1997), and B. Matsumoto, Methods in Cell Biology: Cell Biological Applications of Confocal Microscopy (Academic Press, 1993), are well-known treatises discussing video microscopy and confocal microscopy respectively. R. N. Ghosh et al., “Cell-Based, High-Content Screen for Receptor Internalization, Recycling and Intracellular Trafficking,” Biotechniques 29(1): 170-75 (2000), discloses a cell-based fluorescent imaging assay that detects and quantifies the presence of fluorescently labeled receptors and macromolecules in the recycling compartment. A method for non-invasive biomedical optical imaging and spectroscopy using a modulated light source is disclosed in U.S. Pat. No. 5,865,754 (Fluorescence Imaging System and Method), which is hereby incorporated by reference. A photon migration analysis technique to analyze the diffuse reflectance, fluorescence, Raman or other types of spectra obtained from tissue is disclosed in U.S. Pat. No. 5,452,723 (Calibrated Spectrographic Imaging), which is hereby incorporated by reference. U.S. Pat. No. 5,741,648 (Cell Analysis Method Using Quantitative Fluorescence Image Analysis), which is hereby incorporated by reference, teaches automated quantitative fluorescence image analysis of cell samples, using certain autofluorescence correction methods.

Also well known in the art are various methods for dynamic image acquisition and analysis. For example, U.S. Pat. No. 6,008,010 (Method and Apparatus for Holding Cells), which is hereby incorporated by reference, teaches a method for acquiring digitized images resolving cell shape (in particular, progression of cytokinesis) at the single cell level, allowing for robotic intervention into the microenvironments of the imaged cells to enhance the growth of certain cell types. U.S. Pat. No. 5,655,028 (Dynamic Image Analysis System) describes a system for tracking deformable moving objects and for analyzing dynamic images of these deformable moving objects. U.S. Pat, Nos. 5,989,835 (System for Cell-Based Screening) and 6,103,479 (Miniaturized Cell Array Methods and Apparatus for Cell-Based Screening) teach methods for the array-based, high-volume acquisition of time-series fluorescence, radioactivity, and light microscopy images at subcellular spatial resolution and multiple z focal planes; both patents are hereby incorporated by reference.

Another reference, R. Y. Tsien, “Intracellular Signal Transduction in Four Dimensions: From Molecular Design to Physiology,” Am. J. Physiol. 263(4 Pt 1): C723-28 (1992), teaches a method for dynamic imaging of intracellular concentrations of important ions and messengers such as Ca²⁺, Na⁺, H⁺, and adenosine-3′, 5′-cyclic monophosphate. C. M. Hempel et al., “Spatio-Temporal Dynamics of Cyclic AMP Signals in an Intact Neural Circuit,” Nature 384(6605): 166-69 (1996), describes a method for studying the distribution and diffusion of cyclic AMP (cAMP) in the neurons of the lobster stomatogastric ganglion using a cAMP-indicator dye, FICRhR. Similarly, the references, L. A. Blatter, “Confocal Imaging of Cardiovascular Cells,” The Circulation Frontier 4: 26-34 (2000), and L. A. Blatter & E. Niggli, “Confocal Near-Membrane Detection of Calcium in Cardiac Myocytes,” Cell Calcium 23: 269-79 (1998), describe techniques for determining the spatio-temporal pattern of action potential-induced [Ca²⁺]₁ -transients in atrial and ventricular myocytes using confocal microscopy recorded in the linescan mode.

The term “image data,” within the meaning of this patent, refers to data incorporating spatial information in some form. This term would encompass traditional “pictures” such as electron micrographs and other “visual” data. The term “image data” also includes gene-chip and other microarray data. Image data need not be stored or displayed in a form that is perceptible to the naked eye, so long as the data includes spatial information (e.g., location of a signal, and not just the magnitude of the signal).

In a preferred embodiment, the acquired images are fluorescence images. Various fluorescent dyes or fluorescently labeled probes can be used to measure structural or functional properties of a biological or physiological system. (For example, there are probes designed to measure structural properties such as the presence of certain DNA base pairs, the presence and level of mRNA, or the presence and level of certain antigens or proteins; probes can also measure functional properties such as mitochondrial activity, calcium levels, electrical membrane potential, cell membrane microviscosity, cell viability or pH levels.) U.S. Pat. No. 5,989,835 (System for Cell Based Screening), which is hereby incorporated by reference, provides a useful overview of the literature teaching fluorescence probe loading and image acquisition (at column 2 of the patent).

In addition to “extrinsic” probes (e.g., foreign molecules introduced into a cell, organ or tissue), certain native molecules are also fluorescent or can be induced to fluoresce under certain conditions. Because introduction of an extrinsic fluorophore may perturb the system being studied (sometimes in an unpredictable manner) and, indeed, may even adversely affect the viability of the cell or biological system, it is often advantageous to measure the fluorescence of an “intrinsic” probe.

A recent review paper, K. A. Giuliano & D. L. Taylor, “Fluorescent-Protein Biosensors: New Tools for Drug Discovery,” Trends in Biotechnology 16:135-40 (1998), surveys the technical literature relating to fluorescent-protein biosensors and fluorescence measurement techniques. The article describes a number of new applications of fluorescent-protein biosensors and teaches which biosensors and fluorescence measurement techniques are suitable for measuring certain biochemical, biophysical or physiological properties. For example, as reported in J. E. Gonzalez & R. Y. Tsien, “Voltage Sensing by Fluorescent Energy Transfer in Single Cells,” Biophys. J. 69: 1272-80 (1995), it is possible to measure in vivo membrane potential changes by determining the fluorescence-resonance energy transfer (FRET) between a fluorescently labeled lectin and a membrane-bound oxonol dye whose dynamic partitioning in the plasma membrane is dependent on the electrical potential across the membrane.

As a further example, U.S. Pat. No. 5,605,809 (Compositions for the Detection of Proteases in Biological Samples and Methods of Use Thereof), which is hereby incorporated by reference, describes how apoptosis-related intracellular protease activity can be measured using a peptide substrate labeled with two fluorophores in a stacked conformation that quenched their fluorescence. The cleavage of the U-shaped peptide by a specific protease into two independent chains permits the dye attached to each chain to become fluorescent.

Further examples of fluorescence measurement techniques are described in M. Deutschet al., “Analysis of Enzyme Kinetics in Individual Living Cells Utilizing Fluorescence Intensity and Polarization Measurements,” Cytometry 39(1): 36-44 (2000); and M. Deutschet al., “Fluorescence Polarization as an Early Measure of T-Lymphocyte Stimulation,” Methods Mol. Biol. 134: 221-42 (2000). The former article teaches that in vivo cellular enzyme kinetics can be measured through fluorescence intensity (FI) and fluorescence polarization (FP) measurements of fluorescein diacetate (FDA) and chloromethyl fluorescein diacetate (CMFDA) intracellular hydrolysis using Cellscan mark-S (CS-S) scanning cytometer.

Certain semiconductor nanocrystals are also suitable for use as fluorescent probes in biological staining and diagnostics, as more fully elucidated in M. Bruchezet al., “Semiconductor Nanocrystals As Fluorescent Biological Labels,” Science 281: 2013-16 (1998). Compared with conventional fluorophores, the nanocrystals have a narrow, tunable, symmetric emission spectrum and are photochemically stable. These nanocrystal probes are thus complementary and in some cases may be superior to existing fluorophores. Bruchez demonstrated the advantages of the broad, continuous excitation spectrum in a dual-emission, single-excitation labeling experiment on mouse fibroblasts.

Yet another example of a fluorescence measurement technique is described in C. C. Finket al., “An Image-Based Model of Calcium Waves in Differentiated Neuroblastoma Cells,” Biophys. J. 79(1): 163-83 (2000). That reference describes how successive snapshots of the fluorescence intensity of a Ca²⁺ probe Fura-2 was used to visualize the propagation of intracellular calcium waves in differentiated neuroblastoma cells.

All of the above-described fluorescence measurement techniques, as well as numerous others not described above, are well known in the art. The selection of the appropriate measurement technique and/or associated fluorescent probe will depend upon the physiological or biological variable being measured, but is within the skill of the ordinary artisan.

Although numerous fluorescent probes may be used without departing from the scope of this invention, a preferred probe is green fluorescent protein (GFP) and its variants (e.g., enhanced GFP, such as EGFP, EBFP (enhanced blue fluorescent protein), EYFP (yellow), and ECYP (cyan)). GFP is a naturally occurring protein found in the bioluminescent jellyfish Aequorea victoria, and has been cloned and expressed in a number of other systems. The properties of, and protocols for using, GFP and GFP fusions are well known, and have been extensively described in the literature. For example, three well known treatises are P. M. Conn, J. N. Abelson & M. I. Simon, Methods in Enzymology: Green Fluorescent Protein (Academic Press, 1999); and M. Chalfie & S. Kain, Green Fluorescent Protein: Properties, Applications and Protocols (John Wiley & Sons, 1998); K. F. Sullivan & S. A. Kay, Methods in Cell Biology: Green Fluorescent Protein (Academic Press, 1998).

The advantages of using GFP as a fluorescent label include the fact that the molecule was been studied extensively and is well understood. In addition, GFP and its variants are available commercially—for example, from CLONTECH Laboratories, Inc. (Palo Alto, Calif). Furthermore, numerous techniques have been developed using GFP as a reporter for gene expression and/or protein localization in a wide variety of experimental systems, both prokaryotic and eukaryotic. Additionally, detection of GFP can be performed in living samples and is amenable to real-time analysis of biochemical, biophysical or physiological events. Finally, instrumentation for detecting GFP fluorescence and acquiring images from GFP-labeled experimental systems are commercially available, including high-throughput automated imaging systems such as those available from Praelux, Inc. (Lawrenceville, N.J.) (formerly known as SEQ Ltd. and recently acquired by Amersham Pharmacia Biotech) and Cellomics Inc. (Pittsburgh, Pa.).

The Simulation Model

In step 230 of FIG. 2, the current state (at time tₖ) of the biological or physiological system is forecasted using a biological or physiological model capable of predicting the dynamic spatial distribution of various biological and physiological variables. As expressed in the block diagram of FIG. 2, the state vector xₖ₋₁ at time tₖ₋₁ is propagated forward to time tₖ (thereby generating a prediction of the state of the system at time tₖ), and the state transition matrix D is updated. The state transition matrix represents a linear approximation to the transformation of the state at time tₖ₋₁ to the state at time tₖ. For certain simulation models and for certain filters, it is not necessary to calculate the state transition matrix. Notably, this initial prediction of the state vector does not take into account the newly acquired image, yₖ.

The simulation model need not predict the spatial distribution of every variable; indeed, there may be many variables whose distribution is uniform or otherwise not of interest to the modeler. Moreover, the model need not be explicitly “spatial” as long as the simulation model, coupled with the image-generation model, is capable of predicting how at least one variable varies temporally and in at least one spatial dimension.

Furthermore, it is not necessary for the simulation model to be able to forecast the value of every variable relevant to the model. Indeed, the claimed invention is operable even where the simulation model is semi-quantitative in nature; that is, the model is able to predict at least the correct direction in which each variable will change to provide correct partial ordering of the magnitude of change relative to other variables (but not necessarily the absolute value of each variable).

Numerous simulation models—a number of which are described above—may be used to make predictions about the spatiotemporal evolution of a biological or physiological system. Some examples include the In Silico Cell™ modeling platform and the Virtual Cell modeling software described above. The selection of the appropriate simulation model will depend upon the nature of the system being modeled; and a skilled artisan would be capable of selecting the appropriate simulation model.

Typically, the simulation model for a particular biological or physiological system would comprise a set of coupled ordinary differential equations (ODEs) or partial differential equations (PDEs), which describe the spatiotemporal evolution of the variables governing the system in question, as well as the relationship between these variables. In certain cases, the system being modeled may be simple enough to be modeled by a system of coupled algebraic equations. Various ODE and PDE solvers are available commercially (or can easily be developed) for solving the system of ordinary or partial differential equations.

The user may specify the simulation model in advance, or one model from a set of models may be selected automatically based upon patterns detected in the experimental data (including, for example, the acquired image data) collected. For example, machine-learning algorithms may be used to select a specific simulation model or to determine the values of parameters used in a selected simulation model.

Initializing the Simulation Model

For many simulation models, it will be necessary to specify or estimate the initial conditions of the system being modeled. For example, as illustrated in FIG. 2, step 200 involves estimating the a priori state of the system, X_{0A}, as well as the initial error covariance matrix, P₀, and the state noise covariance matrix, Q₀, based on initial image and other data. One method for estimating the a priori state comprises acquiring an initial image and then applying the inverse of the image-generation model to the acquired image to derive initial values of the underlying state variables (or some subset of the underlying state variables). To estimate the initial concentration distributions of unprobed metabolites and other variables, one may rely on population statistics from the literature or, in the worst case, guess the value. Alternatively, one may assume that the system is in steady state initially, and estimate the a priori state by setting the parameters and initial conditions equal to the steady-state solution of the mathematical model at time t=0.

The covariance matrix estimates encapsulate the degree of confidence in the values of the parameters and values in the state vector. Parameter values known with a high degree of certainty may be left out of the state vector expression and “hard coded” into the simulation model itself. Parameters with a high degree of uncertainty should be fitted more aggressively using a filtering method (as described in more detail below).

Image Generation and Comparison In step 240 of FIG. 2, one calculates the predicted image, gₖ, based on the predicted state vector using a suitable image-generation model, which should take into account the physics of the image-acquisition process/device and the effects of random error sources on the image. In addition, for certain filters, it is useful to calculate Gₖ, the Jacobian of the image matrix, gₖ, with respect to x at t=tₖ.

Generally, it is preferable to compare the prediction and the experimental data in “image space” rather than in “state space” because transforming the image data into state-space data (using an inverse image-generation model) is often a difficult and possibly intractable problem. However, in certain cases, it may be possible and, indeed, preferable to make the comparison in state space or some space constituting a transformation of state space or image space.

Model Calibration

After comparing the predicted image, gₖ, with the acquired image, Yₖ, one then “corrects” the simulation model such that the new predicted image is “closer” to or more like the acquired image. In short, one adjusts or modifies the state estimate in order to minimize or reduce some error measure or metric that is a measure of the “goodness of fit” between the predicted data and the experimental data. One may explicitly calculate an error measure (such as the sum of the squares of the differences in pixel intensity for each pixel in the predicted image and the intensity of the corresponding pixel in the acquired image), and then adjust the simulation model parameters systematically until the error measure is minimized or reduced; alternatively, one may use a calibration method that inherently minimizes or reduces some error measure (without explicitly computing the error measure). As represented in FIG. 2, the model calibration process is accomplished in steps 250 to 270.

One approach to model calibration includes the use of a neural network model for adjusting the parameters of the simulation model and/or modifying the structural features of the simulation model used to predict the spatiotemporal evolution of the biological or physiological system. See S. Haykin, Neural Networks: A Comprehensive Foundation (Macmillan, 1994), and A. Lapedes & R. Farber, Nonlinear Signal Processing Using Neural Networks: Prediction and System Modelling (Los Alamos National Laboratory Technical Report LA-UR-87-2662, 1987). For example, a standard multi-layer perceptron (MLP) neural network may be applied to the time-series data. Preferably, however, a recurrent neural network (RNN) model, which is better suited to detection of temporal patterns, would be used. In particular, the Elman neural network is a RNN architecture that may be well suited for noisy time series. See J. L. Elman, “Distributed Representations, Simple Recurrent Networks, and Grammatical Structure,” Machine Learning 7(2/3): 195-226 (1991).

Hybrid neural network algorithms may also be applied. For example, prior to the grammatical inference step (i.e., using a neural network to predict the evolution of the time series), one may use a self-organizing map (SOM) to convert the time series data into a sequence of symbols. A self-organizing map is an unsupervised learning process, which “learns” the distribution of a set of patterns without any class information. A pattern is projected from a (usually) high-dimensional input space to a position in a low-dimensional display space. The display space is typically divided into a grid, and each intersection of the grid is represented in the network by a neuron. Unlike other clustering techniques, the SOM attempts to preserve the topological ordering of the classes in the input space in the resulting display space. See T. Kohonen, Self-Organizing Maps (Springer-Verlag, Berlin, 1995). Symbolic encoding using a SOM makes training the neural network easier, and aids in the extraction of symbolic knowledge.

A preferred method for adjusting the simulation model is to apply a batch estimator or recursive filter. Preferably, a fading-memory filter is used; and more preferably, the Kalman filter or one of its variants is used. The Kalman filter and its variants are described in great detail in numerous references, including A. Gelb, Applied Optimal Estimation (MIT Press, Cambridge, Mass., 1974); R. G. Brown & P. Y. C. Hwang, Introduction to Random Signals and Applied Kalman Filtering (2nd ed., John Wiley & Sons, 1992); M. S. Grewal & A. P. Andrews, Kalman Filtering Theory and Practice (Prentice Hall, 1993); Sorenson, H. W. 1970. “Least-Squares Estimation: From Gauss to Kalman,” IEEE Spectrum 7: 63-68 (1970); P. S. Maybeck, Stochastic Models, Estimation, and Control (Academic Press, 1979); R. Lewis, Optimal Estimation with an Introduction to Stochastic Control Theory (John Wiley & Sons, Inc., 1986); and N. R. Amundson, Mathematical Methods in Chemical Engineering (Prentice-Hall, 1966).

The Kalman filter addresses the problem of trying to estimate the state x of a process (such as a biological process) that is governed by the stochastic differential equation

dx/dt=f(x)+w(t)

with a measurement vector y defined

yₖ=g(xₖ, t)+v(t)

where random variables w and v represent the process and measurement noise respectively.

One can define an a priori state estimate at step k, xₖ^{*-} (note the “super minus”), which takes into account the state of the system prior to step k but does not take into account the new measurement yₖ. One may then compute an a posteriori state estimate xₖ^{*} as a linear combination of the a priori state estimate xₖ^{*-} and the weighted difference between the actual measurement yₖ and the measurement prediction Gxₖ^{*-}:

xₖ^{*}=xₖ^{*-}+Kₖ(yₖ−Gxₖ^{*-})

where G is a m×n matrix relating the state xₖ to the measurement yₖ, the residual (yₖ−Gxₖ^{*-}) reflects the discrepancy between the predicted measurement and the actual measurement Yₖ, and Kₖ is the n×n gain matrix that minimizes the a posteriori error covariance.

In FIG. 2, the gain matrix is calculated in step 250. The appropriate formula for the gain matrix would depend upon the filter used to calibrate the simulation model. For the Kalman filter, the gain matrix can be calculated:

Kₖ=Pₖ⁻(tₖ)Gₖ^{T}(Rₖ+GₖPₖ⁻(tₖ)Gₖ^{T}) ⁻¹

where Pₖ₋ is the a priori estimate error covariance, Rₖ is the measurement error covariance, and Gₖ is the Jacobian of gₖ with respect to xₖ. For the pseudo-inverse filter, the gain matrix can be calculated:

Kₖ=Gₖ^{T}(GₖGₖ^{T})⁻¹

In step 260, the state noise covariance, Q(tₖ, tₖ₋₁), and error covariance, Pₖ₋₁(tₖ), are propagated forward based upon the calculated gain matrix, Kₖ. In step 270 in FIG. 2, one calculates an updated a posteriori state estimate for time tₖ, to get xₖ(tₖ). In addition, one updates the error covariance matrix, Pₖ(tₖ), and the state covariance matrix, Qₖ(tₖ), if using an adaptive filter. Finally, in step 290, one applies the image-generation model to the new a posteriori state estimate in order to generate an “improved” image.

Detection of Undamped Random Disturbances

Certain biological events involve spontaneous symmetry breaking in a system due either to an unmeasurable bias or a random event that is amplified robustly and persistently by the system. Two examples are: (1) establishment of a mitotic plane prior to cell division; and (2) the spontaneous morphological polarization (and concomitant asymmetric recruitment of GFP-PH to the plasma membrane) of an initially rounded neutrophil exposed to a spatially uniform increase in chemoattractant (i.e., fMLP) concentration.

A good deterministic model, with a supplied pseudorandom noise term with the correct characteristics, could be used to model certain symmetry-breaking events, for example, the establishment of a polarization direction and the subsequent commitment of the molecular machinery to that direction. Unfortunately, it would be nearly impossible to predict the occurrence of the random perturbation triggering the symmetry-breaking state trajectory. Comparisons between a single experimental outcome with one specific randomly generated prediction of the model would be meaningless. Hence, such models could only be validated (and model parameters fitted) by comparing the statistics of several runs to the statistics of many experiments.

However, applying the claimed method (in particular, the Kalman or recursive filter embodiments), one would be able to detect the onset of the symmetry-breaking event and then track the evolution of the system state after the symmetry-breaking event. In fact, the time of onset of the symmetry-breaking event may be the variable of interest in high-content screening assays or in the robotic micro-control system described in U.S. Pat. No. 6,008,010.

Notably, this application of the claimed method does not require the use of image data; as to this specific embodiment of the invention, any time-series data (including completely non-spatial data) may be used to detect the random perturbation. Moreover, it is not necessary for the system state to be “symmetrical” spatially or otherwise prior to the random perturbation. More generally, it is only necessary that certain random/stochastic events (which are not deterministically predictable by the model) trigger significant alterations in the state trajectory, and that the altered state trajectories are predictable by the model once the time at which the random disturbance occurs is specified. In addition, the perturbation need not be truly random or stochastic in nature; rather, it is only necessary that the occurrence of the perturbation is not modeled by the simulation model (either because the perturbation cannot be predicted or because a deterministic prediction would be unduly computationally expensive). Under these conditions, one may use the claimed method in conjunction with a fading-memory filter and time-series data to detect the occurrence of the random disturbance and then forecast the altered state trajectory.

### EXAMPLE 1

One potential application of the invention is predicting the spatiotemporal dynamics of various marker concentration fields in a cell with static geometry. For the physiological simulation model, one may employ the Virtual Cell modeling environment. More specifically, one may use the model of cytosolic Ca²⁺ wave propagation in a differentiated neuroblastoma cell described in J. C. Schaff et al., “Physiological Modeling with the Virtual Cell Framework,” Methods Enzymol. 321: 1-23 (2000); C. C. Fink et al., “An Image-Based Model of Calcium Waves in Differentiated Neuroblastoma Cells,” Biophys. J., 79: 163-183 (2000); and B. M. Slepchenko, J. C. Schaff & Y. S. Choi, “Numerical Approach to Fast Reactions in Reaction-Diffusion Systems: Application to Buffered Calcium Waves in Bistable Models,” J. Comput. Phys., 162: 186-218 (2000).

Information about the state of the system may be stored as a state vector x—an M-component vector comprising an array of numbers representing the spatial distribution of those model metabolites that will vary spatially and temporally during the model simulation. For example, the intracellular calcium concentrations may be stored as a vector {[Ca²⁺]₁, [Ca²⁺]₂, . . . [Ca²⁺]_{N}}, where each element of the vector represents the calcium concentration [Ca²⁺] at each of the finite volume nodes of the model. In addition to calcium concentrations and the values of temporally varying variables, the simulation model would also store an array of numbers representing the spatial distribution of model quantities that do not change during the course of the simulation.

The state vector may also include an array of scalar model parameters, such as kinetic rate constants, which do not vary spatially or temporally. For this example system, such parameters include: the average flux density amplitude, J₀; the flux time constant, k₀; the average amplitude of the pump intake, Vₘₐₓ; the on-rate for Ca²⁺ binding to inhibition site, kₒₙ; and the dissociation constant for IP3 binding to a channel, K_{IP3}.

The time-series images of interest for this example system are fluorescence images of the intracellular calcium indicator Fura, collected at regular time intervals using a CCD camera. The image-generation model should include a mathematical description of the effects of microscopy and three-dimensional cell shape on the projected fluorescence image, using techniques such as those taught by C. Finket al., “Intracellular Fluorescent Probe Concentrations by Confocal Microscopy,” Biophys. J. 75(4): 1648-58 (1998), for the generation of successive confocal slices, or a single two-dimensional image for the fluorescence measured across the thickness of the cell.

An example of a suitable error measure is the L₂ norm

||gₖ−yₖ||₂=(<gₖ−yₖ, gₖ−yₖ>) ^{½}

on the difference between the image data yₖ (represented as a vector representing the fluorescence intensity at each pixel) and the predicted image data gₖ, also in vector form. One may use any suitable fading-memory filter, such as the extended Kalman filter, for the parameter fitting.

### EXAMPLE 2

Another application of the invention is to develop models for predicting motion and mechanical forces in biological systems. For the physiological simulation model, one may use the model of spatiotemporal intracellular signal dynamics coupled to a model for intracellular mechanical force generation. An example of an appropriate mechanical force generation model is described in D. C. Bottino, “Modeling Viscoelastic Networks and Cell Deformation in the Context of the Immersed Boundary Method,” J. Computational Phys. 147: 86-113 (1998), and D. C. Bottino & L. J. Fauci, “A Computational Model of Ameboid Deformation and Locomotion,” Eur. Biophys. J. 27: 532-39 (1998). The simulation model predicts the temporal evolution of cell shape and traction forces exerted on the substrate.

The time-series images can be (a) images of rhodamine-labeled cells, (b) light microscope images, and/or (c) images of the cell on a latex-bead embedded substrate. The image-generation model should produce a simulated image giving cell position and shape, in addition to bead displacements predicted by solving the elasticity equations in response to predicted traction force fields.

Suitable error measures include: (a) the difference between the area enclosed by actual cell contours and the area of predicted cell shape and position; (b) the sum-squared magnitudes of the differences between predicted and measured bead displacements; or (c) a weighted sum of (a) and (b). Any filter could be used, but a Kalman-type filter may be more robust in this situation due to the random nature of cell protrusion and locomotion, even in the presence of a chemoattractant gradient.

### EXAMPLE 3

Yet another application is the development of predictive models of the spatiotemporal dynamics of marker images at the tissue and organ level using a finite-element or finite-difference modeling software. One example of a finite-difference modeling software package is CMISS, which was developed by the University of Auckland.

A suitable physiological simulation model for predicting spatiotemporal action-potential dynamics on the heart surface would be the model disclosed and claimed in U.S. Pat. No. 5,947,899 (Computational System and Method for Modeling the Heart), which is hereby incorporated by reference. The time series images can be CCD images of the fluorescence intensity of voltage-sensitive dyes on an experimentally stimulated mammalian heart.

An appropriate error measure would be the L₂ norm, as described in Example 1 above. Suitable filters would include the Kalman filter and other recursive filters, due to the immense size of the state vector.

### EXAMPLE 4

Furthermore, the invention may be applied to models for predicting the temporal evolution of gene expression in living cells. One would utilize a physiological simulation model that predicts the temporal evolution of gene expression (e.g., mRNA levels for various open reading frames in the cell's genome) in a large cell population under controlled experimental conditions. Each image in the time series is obtained by (1) removing a sample of cells from the study population at a particular time point during the progression of the experiment and (2) producing a gene expression array image using that sample. The intensity of each array node indicates the relative concentration of the mRNA for that particular open reading frame, or suspected gene. Each expression array should then represent a “snapshot” of the relative expression levels in the cell population at the time the sample was removed.

The image-generation model should convert the predicted intracellular mRNA concentrations to the expected array fluorescence intensities. The error measure could be based on a simple image difference (like the examples above). Alternatively, one could convert the experimental image data to an array of total fluorescence at each gene array node. Many different types of filters can be used, including Kalman-type filters.

### EXAMPLE 5

Another possible application of one embodiment of the claimed invention is parameter estimation for an electrophysiological model using a batch or recursive filter. Electrophysiological models have been developed for various cell and tissue types (e.g., cardiac cells, neurons) and have been extensively studied. Well known electrophysiological models include the Luo-Rudy model, see C. H. Luo & Y. Rudy, “A Model Of The Ventricular Cardiac Action Potential, Depolarization, Repolarization, And Their Interaction,” Circ. Res. 68: 1501-26 (1991); C. H. Luo & Y. Rudy, “A Dynamic Model Of The Cardiac Ventricular Action Potential I: Simulations Of Ionic Currents And Concentration Changes,” Circ. Res. 74: 1071-96 (1994); C. H. Luo & Y. Rudy, “A Dynamic Model of The Cardiac Ventricular Action Potential. II: After depolarizations, Triggered Activity, And Potentiation,” Circ. Res. 74: 1097-113 (1994), and the Hodgkin-Huxley model, see A. L. Hodgkin & A. F. Huxley, “A Quantitative Description of Membrane Current and Its Application to Conduction and Excitation in Nerve,” J. Physiology 117: 500-44 (1952).

Such models, although relatively simple, can exhibit complex behavior such as bursting oscillations. See P. R. Shorten & D. J. N. Wall, “A Hodgkin-Huxley Model Exhibiting Bursting Oscillations,” Bull. Math. Biol. 62: 695-715 (2000); P. R. Shorten et al., “CRH-Induced Electrical Activity and Calcium Signalling in Pituitary Corticotrophs,” J. Theoretical Biol. 206(3): 395-405 (2000). To test the effectiveness of the Kalman filter as a parameter estimation tool, “pseudo-data” was generated using a modified Hodgkin-Huxley model of the action potential activity of pituitary corticotroph cells (the “MHH Model”). See A. P. LeBeau et al., “Generation of Action Potentials in a Mathematical Model of Corticotrophs,” Biophys. J. 73: 1263-75 (1997); A. P. LeBeau et al., “Analysis Of A Reduced Model Of Corticotroph Action Potentials,” J. Theoretical Biol. 192(3): 319-39 (1998).

For the MHH Model used in this example, the equation for the current is given by:

I_{Ca}=gm²h(V−E_{Ca}) (1)

where g is the macroscopic conductance, V is the membrane potential, and E_{Ca} is the reversal potential for the Ca²⁺ current. The time- and voltage-dependent gating variables m and h (referred to as the activation and inactivation gates respectively) vary between 0 and 1, and are given by the following differential equations:

$$\begin{matrix}\dot{m} = \frac{{m}_{∞} ( V ) - m}{{τ}_{m} ( V )} \\ \dot{h} = \frac{{h}_{∞} ( V ) - h}{{τ}_{h}}\end{matrix} \qquad ( 2 )$$

The variable m_{∞} represents the fraction of activation gates in the open state at steady-state conditions, and is a function of the membrane potential:

$${m}_{∞} ( V ) = \frac{1}{1 + {e}^{\frac{- ( V - {V}_{m} )}{{k}_{m}}}} \qquad ( 3 )$$

where Vₘ is the membrane potential of the mid-point activation of the m gate, and kₘ is the slope factor of the m_{∞} curve.

The variable τₘ in Equation (2) is the relaxation time function governing the dynamics of the activation gate, and is also a function of membrane potential:

$${τ}_{m} ( V ) = \frac{{τ}_{m0}}{{e}^{\frac{V - {V}_{τ}}{{k}_{τ}}} + 2 {e}^{\frac{- 2 ( V - {V}_{τ} )}{{k}_{τ}}}} \qquad ( 4 )$$

where τₘ₀, and V_{τ} and k_{τ} are constants characterizing the voltage dependence of the τₘ curve.

The constant τₕ in Equation (2) is the relaxation time constant governing the dynamics of the inactivation gate. The variable h_{∞} represents the fraction of inactivation gates in the non-inactivated state at steady-state conditions, and is governed by the following equation:

$${h}_{∞} ( V ) = \frac{1}{1 + {e}^{\frac{V - {V}_{h}}{{k}_{h}}}} \qquad ( 5 )$$

where Vₕ is the membrane potential of the mid-point inactivation of the h gate, and kₕ is the slope factor of the h_{∞} curve.

For the simulations used in this example, the following parameter values were used:

TABLE 1

| | |
|---|---|
| Parameter | Value |

| | | |
|---|---|---|
| g | 10 | nS |
| E_{Ca} | 60 | mV |
| Vₘ | −30 | mV |
| kₘ | 10.5 | mV |
| τₘ0 | 10 | ms |
| Vₜ | −60 | mV |
| kₜ | 22 | mV |
| Vₕ | −57 | mV |
| kₕ | 5 | mV |
| τₕ | 15 | ms |

Although it would be possible to apply the parameter estimation techniques disclosed herein to simulation results directly generated by the above-described deterministic model, the “data” generated by such a simulation would not be reflective of real experimental data, which would be affected by both process noise and measurement noise. In order to simulate real experimental data, “noise” can be added to the deterministic simulation results. This can be accomplished in a number of ways. For example, measurement noise can be simulated by adding a Gaussian noise term to the values generated by integrating or solving the deterministic differential equations. (Measurement noise was not added to the data sets described in this example.) Process noise can be simulated in several ways, including (1) solving the stochastic differential equations corresponding to the above model equations; or (2) simulating the behavior of the ion channels as a stochastic process (using, for example, Monte Carlo simulation or a variant such as Gillespie's method).

Gillespie's Method

For the simulations used in this example, Gillespie's method was applied to simulate stochastic gating. See G. D. Smith & J. E. Keizer, “Modeling the Stochastic Gating of Ion Channels,” Computational Cell Biology, C. P. Fall, E. Marland, J. Wagner & J. Tyson, eds., pp. 321-55 (Springer, New York, 2001); D. T. Gillespie, “Exact Stochastic Simulation of Coupled Chemical Reactions,” J. Phys. Chem. 81: 2340-61 (1977).

To apply Gillespie's method, one must know the rate of transition between gating states: between open and closed for the m gate; and between inactivated and noninactivated for the h gate. The state-transition diagrams can be represented as:

$${C}_{m} {{⇄}^{ {α}_{m} ( V ) }}_{{β}_{m} ( V )} {O}_{m}$$

$${I}_{h} {{⇄}^{ {α}_{h} ( V ) }}_{{β}_{h} ( V )} {NI}_{h}$$

where Cₘ and Oₘ represent the closed and open states respectively for the m gate; Iₕ and NIₕ represent the inactivated and non-inactivated states for h gate; and the variables αₘ, βₘ, αₕ, and βₕ represent the voltage-dependent forward and reverse rate constants for the state transitions depicted.

Notably, in the MHH Model, m represents the fraction of open gates, (1−m) represents the fraction of closed gates, h represents the fraction of non-inactivated gates, and (1−h) represents the fraction of inactivated gates. The differential equations in Equation (2) above can be rewritten as

$$\begin{matrix}\begin{matrix}\dot{m} = {α}_{m} ( V ) ( 1 - m ) - {β}_{m} ( V ) m = {α}_{m} ( V ) - ( {α}_{m} ( V ) + {β}_{m} ( V ) ) m \\ \dot{h} = {α}_{h} ( V ) ( 1 - h ) - {β}_{h} ( V ) h = {α}_{h} ( V ) - ( {α}_{h} ( V ) + {β}_{h} ( V ) ) h\end{matrix} \\ where & ( 6 ) \\ \begin{matrix}{α}_{m} ( V ) = \frac{{m}_{∞} ( V )}{{τ}_{m} ( V )} , {α}_{h} ( V ) = \frac{{h}_{∞} ( V )}{{τ}_{h}} \\ {β}_{m} ( V ) = \frac{1 - {m}_{∞} ( V )}{{τ}_{m} ( V )} , {β}_{h} ( V ) = \frac{1 - {h}_{∞} ( V )}{{τ}_{h}}\end{matrix} & ( 7 )\end{matrix}$$

Hence, Equation (2) of the MHH Model can be rewritten in terms of the voltage-dependent forward and reverse rate constants governing state transitions for the m and h gates.

While the variables m and h are continuous on the interval [0, 1] in a classical Hodgkin-Huxley model, Gillespie's method simulates a discrete state model, where m and h can each take one of two values—0 or 1, which correspond to the closed or open states for the m gate, and the inactivated or non-inactivated states for the h gate, respectively. Because the equation for the Ca²⁺ current—Equation (1) above—includes an m² term, it is necessary to simulate two sets of m gates, m₁ and m₂, which are subsequently multiplied together to generate the m² term of the measurement model. In this way, the stochastic behaviors of the three gates are entirely independent.

In order to simulate the macroscopic behavior of the system, one must simulate the behavior of a large number of individual channels or gates, and then calculate the average behavior of all of these individual channels to determine values of m and h to be used in the MHH Model. For the simulations discussed in this example, one thousand (1000) channels were simulated and then averaged to generate each pseudo-dataset.

For each simulation, the channels were initialized based upon the steady-state distribution of the open/closed and inactivated/non-inactivated channels at the initial holding potential, V(0). From simple kinetic theory, the steady-state distribution of gates in the 1 state (i.e., open or non-inactivated) is equal to β/(α+β). Accordingly, a random number generator is used to generate a random number uniformly distributed between 0 and 1 for each gate; and if that random number is greater than the fraction β/(α+β), the gate is initialized to 1. Otherwise it is initialized to 0.

It is also necessary to initialize times until the next state change for each of the gates. It can be shown that the time to transition from a 0 state to a 1 state and vice versa is given respectively by the equations:

$$\begin{matrix}{τ}_{0} = \frac{- 1}{α} ln ( U ) \\ {τ}_{1} = \frac{- 1}{β} ln ( U )\end{matrix} \qquad ( 8 )$$

where U is a random variable uniformly distributed on the interval [0,1]. For the two gates m and h, the two equations can be combined to yield:

$$\begin{matrix}{τ}_{m} = - ( \frac{( 1 - m )}{{α}_{m}} + \frac{m}{{β}_{m}} ) ln ( U ) \\ {τ}_{h} = - ( \frac{( 1 - h )}{{α}_{h}} + \frac{h}{{β}_{h}} ) ln ( U ) .\end{matrix} \qquad ( 9 )$$

The initial “time of next transition” is calculated for all gates using the appropriate version of Equation (9).

After all gates have been properly initialized, a time range for the simulation is chosen based upon the length of the voltage-step protocol being used. It is also necessary to choose a time step, Δt, which is the increment by which the time variable is increased during each loop of the simulation. It is important that Δt be chosen such that it is significantly smaller than the fastest dynamics of the process being modeled to avoid the introduction of systematic errors.

For the simulations used in this example, Δt was chosen to be 50 μs (whereas the time constants governing the system dynamics are on the order of 1-2 ms). After the step size is selected, the program code for the simulation program loops through the time points, starting with t₁=Δt. In general, tₖ=k·Δt.

At each time step, the simulation algorithm first checks if the voltage applied is the same as the voltage in the previous step. If the voltage has not changed, the algorithm checks whether, for each gate, sufficient time has elapsed (based upon the calculated “time of next transition”) for a state change to occur for that gate. If sufficient time has elapsed, the gate is switched to the opposite value (i.e., 0→1 or 1→0). Next, the “time until next state change” for that gate is recomputed using the appropriate version of Equation (9) and adding it to the current time, tₖ.

If the voltage has changed since the previous time step, the process is slightly different. Similar to the other case, the algorithm determines whether, for each gate, sufficient time has elapsed for a state change to occur. If sufficient time has elapsed, the value of the gate is switched to the opposite value as previously described. However, instead of recalculating the new “time for next transition” only for the gates that experienced a state change, the “times for next transition” are recalculated for all gates—because the voltage-dependent rate constants governing the state transitions have changed as a result of the change in voltage. Thus, the “times for next transition” are recomputed for all gates using the appropriate form of equation (9) and adding it to the current time, tₖ.

The procedure outlined above is repeated for every time point. At the end of the run, average values for each gate are calculated at each time point. For instance, if 1000 channels are being simulated, then an average is calculated over the 1000 values for the m₁, the m₂, and the h gate for each time point. These average values for the gates are then multiplied together at each time point to produce the m²h term in Equation (1) for the Ca²⁺ current.

Applying the Extended Kalman Filter

Using the above-described methodology, eight data sets were generated. Although the same parameter values were used to generate each data set, the data sets are not identical because of the stochasticity of the data-generation protocol. A modified version of the Extended Kalman Filter (EKF) was then applied to estimate the latter eight parameters listed in Table 1 (i.e., g, E_{Ca}, Vₘ, kₘ, τₘ₀, V_{τ}, k_{τ}, Vₕ, kₕ, τₕ). For each data set, the modified EKF protocol was applied twenty (20) times, in each case using a different set of initial guesses for the parameters to be estimated. For each of the twenty runs, the initial parameter values were randomly generated as a uniformly distributed random variable with a mean equal to the actual parameter value used to generate the data set.

As described previously, to apply the EKF protocol, one must calculate the state noise covariance matrix Q. Notably, for the system modeled in this example, the covariance matrix Q is not constant but rather varies with time. Notably, a basic assumption underlying the Kalman filter method is that the process noise covariance matrix Q is constant. (Other more advanced filters are more suitable for use with a time-varying Q matrix.)

Nevertheless, it is possible to apply the Kalman filter by ignoring the fact that the Q matrix varies with time, and setting the Q matrix equal to the initial state noise covariance matrix Q₀. However, another approach (which was the approach used in this example) is to derive an expression for the time-varying Q matrix and apply the correct Q matrix for each time point.

To derive the expression for the non-constant covariance matrix in this case, one first notes that the process model has the form:

\dot{x}=f(t,x)+w(t) (10)

where the stochastic properties of the process noise term w(t) are characterized by the “spectral density matrix” \tilde{Q} defined by: (ww^{T})=\tilde{Q}(t)δ(t−τ), where δ is the Dirac delta function. Since the Extended Kalman Filter uses the discrete linear approximation to the continuous case in the limit as the epoch intervalΔt→0, the correct Q matrix to apply in the EKF implementation is:

Q=\tilde{Q}Δt. (11)

See A. Gelb, Applied Optimal Estimation p. 121 (MIT Press, Cambridge, Mass., 1974). In the particular case of the MHH Model used in this example, because the m and h gates are assumed to act independently of each other, the spectral density matrix \tilde{Q} of the two-gate process is:

$$\tilde{Q} = [ \begin{matrix}{\tilde{σ}}_{m}^{2} & 0 \\ 0 & {\tilde{σ}}_{h}^{2}\end{matrix} ] \qquad ( 12 )$$

The stochastic ODE process model in this case is:

$$\begin{matrix}\dot{m} = \frac{{m}_{∞} ( V ) - m}{{τ}_{m} ( V )} + {w}_{m} ( t ) \\ \dot{h} = \frac{{h}_{∞} ( V ) - h}{{τ}_{h}} + {w}_{h} ( t )\end{matrix} \qquad ( 13 )$$

Since this problem is perfectly symmetric with respect with m and h, the correct final expression for h will be of the same form as that for m. Hence, the equations derived below for the m gate can be modified by using the appropriate substitutions to apply to the h gate.

The spectral density \tilde{σ}ₘ² of wₘ(t) is given by:

$${\tilde{σ}}_{m}^{2} = \frac{{α}_{m} ( 1 - m ) + {β}_{m} ( m )}{N} \qquad ( 14 )$$

where N is the number of channels of the same type in the cell. See G. D. Smith & J. E. Keizer, “Modeling the Stochastic Gating of Ion Channels,” Computational Cell Biology, C. P. Fall, E. Marland, J. Wagner & J. Tyson, eds., p. 305 (Springer, N.Y., 2001). The proper expression for Q in this EKF implementation can then be obtained by substituting Equation (7) into Equation (14), then substituting Equation (14) into Equation (13), and Equation (12) into (11). The same derivation applies to the h-gate terms.

Although measurement noise was not added to the pseudo-data generated for this example, a small, nonzero measurement noise covariance matrix R =[1] was used because of numerical difficulties (e.g., divide by zero errors) encountered when the covariance matrix R was set to zero. The initial error covariance estimate P₀ was set to [0.1 X₀]², where X₀ is the diagonal matrix of initial values.

Enforcing Boundary Constraints in the Extended Kalman Filter

The EKF procedure applied in this example was modified to prevent various parameter estimates from straying outside of permissible bounds for that parameter. Applying an unconstrained Kalman filter, particularly in a system where certain variables are strictly bounded (e.g., m and h bounded on the interval [0, 1]), can often yield erroneous and, indeed, nonsensical results if one or more parameters are forced outside of physiologically reasonable or permissible bounds during any iteration of the EKF code.

There are various possible approaches for enforcing boundary constraints when applying the Kalman filter or EKF methods, including using Lagrange multipliers, applying a penalty function when updates exceed permissible boundaries, using a reduced gradient method, and simply rejecting any updates that violate a constraint. For example, De Geeter describes a penalty-function method for incorporating constraints into the Kalman Filter objective function. See J. De Geeter et al., “A Smoothly Constrained Kalman Filter, IEEE Trans. on Pattern Analysis and Machine Intelligence, Vol. 19, No. 10, pp. 1171-77 (October 1997). Another example of an approach that may be used is the generalized reduced-gradient method described by Abadie and Carpentier. See J. Abadie & J. Carpentier, “Generalization of the Wolfe Reduced-Gradient Method to the Case of Nonlinear Constraints,” in Optimization, edited by R. Fletcher, pp. 37-47 (Academic Press, New York 1968); J. Abadie & J. Carpentier, “Generalisation De La Methode Du Gradient Reduit De Wolfe An Cas Constraintes Non-Lineares,” in Proceedings, IFORS Conferences, edited by Hertz & Melese (Wiley & Sons, Amsterdam 1966); P. Wolfe, The Reduced Gradient Method, RAND Corporation Manuscript (1962).

For the simulations used in this example, boundary constraints were enforced in two ways. The first method for enforcing a boundary constraint was to apply the damped Newton's method to the gradient of the Kalman Filter objective function. See W. H. Press et al., Numerical Recipes in C: The Art of Scientific Computing (2nd ed. 1992). Using this method, if the standard Kalman filter update would produce an estimate outside of the feasible region, one would apply a state update reduced by a damping factor chosen to keep the current estimate within the feasible region. In other words, the magnitude of the state update is reduced while keeping the direction of the update in state space the same.

In mathematical terms, if the standard Kalman filter update uₖ≡Kₖ(zₖ−h(tₖ, \hat{x}ₖ)) causes the updated state vector xₖ←\hat{x}ₖ+uₖ to fall outside of the constraint region, one would apply a reduced state update equal to the original update uₖ multiplied by a scalar attenuation factor, which would prevent the updated state from leaving the constraint region. (The “constraint region” is defined as the set: {x|bᵢ^{l}≦xᵢ≦bᵢ^{u}, ∀i}, where, for each state variable xᵢ in x, bᵢ^{l} denotes the lower bound for xᵢ and bᵢ^{u} denotes the upper bound, where −∞≦bᵢ^{l}<bᵢ^{u}≦+∞. If bᵢ^{l}=−∞, then xᵢ has no lower bound.) Since \hat{x}ₖ was inside the constraint region, there exists a scalar factor α, where 0<α<1, such that \hat{x}ₖ+αuₖ lies on the boundary of the constraint region.

If the attenuation factor were set equal to α, then the updated state would lie directly on the boundary of the constraint region. This is undesirable because any future updates in the direction of the boundary would therefore have no effect. Hence, in order to “pad” the update (i.e., place the updated state some distance from the constraint boundary), one should apply an attenuation factor \tilde{α}=α(1+62), where β controls the degree of “padding”; for the simulations described in this example, β=0.1.

Accordingly, for the simulations in this example, the standard Kalman gain matrix for this epoch, Kₖ, was replaced by an attenuated gain matrix \tilde{K}ₖ≡\tilde{α}Kₖ. This attenuated gain matrix \tilde{K}ₖ is used both for the state estimation update step and for computing the update to the error covariance matrix Pₖ.

Despite use of the “padding” technique described above, after several consecutive updates in the direction of a particular constraint boundary, the updated state value may be indistinguishable from the boundary value within machine precision (i.e., \tilde{α}≈0). Effectively, the state vector will sit on the boundary and not be affected by any further updates in the direction of the constraint boundary. Under such circumstances, for the EKF protocol applied in this example, a second method is used to enforce the boundary constraint.

Using this “parameter sliding” method, one replaces each row of the Kalman gain matrix Kₖ corresponding to a state variable “pinned” against a boundary, such that the following equations are satisfied:

xₗ=max{xₗ,bₗ^{l}}

xₗ=min{xₗ,bₗ^{u}}

Basically, when it is detected that a state vector lies on a constraint boundary, the Kalman update is projected onto the boundary of the feasible region. That is, the state vector moves or “slides” along a boundary based upon the magnitude of the components of the update vector that are not orthogonal to the constraint boundary. In essence, this method is a special case of the reduced gradient method. See J. Abadie & J. Carpentier, “Generalization of the Wolfe Reduced-Gradient Method to the Case of Nonlinear Constraints,” in Optimization, edited by R. Fletcher, pp. 37-47 (Academic Press, New York 1968}. For a system where the constraints are linear, the reduced gradient method can be explained mathematically as follows:

Summary of Algorithm Used in Example

To summarize, the protocol that was applied in this example is as follows. First, an initialization step is performed. The initial state/parameter estimate \hat{x}⁻=\hat{x}⁻(k=1) was chosen randomly, as described above. Next, the P matrix is initialized: P⁻=P⁻(k=1)=σ²\hat{x}⁻(\hat{x}⁻)^{T},σ=0.1. In applying the Kalman Filter to experimental data, one could initialize the entries of the P matrix based upon the expected or experimentally determined variance for the state variable or parameter in question. The Q and R matrices are initialized as described above.

For each time increment, the following steps are performed, using the state estimate \hat{x}⁻=\hat{x}⁻(k+1) and estimated error covariance P⁻=P⁻(k) from the previous epoch, and the new measurement z.

1. Compute the expected measurement \hat{z} by applying the measurement model h(t,x) to \hat{x}⁻: \hat{z}←h(t,\hat{x}⁻).

2. Compute the linearized measurement model:

$$H = \frac{ⅆ h}{ⅆ x} {\vert}_{{\hat{x}}^{-}} .$$

3. Compute the Kalman gain matrix K: K←P^{-H}^{T}(HP^{-H}^{T}+R)⁻¹.

4. Apply the constraint handling protocol described above.

a) If a state variable xₗ on one of its constraint boundaries, and the proposed update u≡K(z−\hat{z}) threatens to take it out of the constraint region, then the ith row of K is zeroed out.

b) If a state variable is not on a constraint boundary but the proposed update u will take the state vector out of constraint region, replace K←\tilde{α}K as described previously.

5. Update state estimate: \hat{x}←\hat{x}⁻+K(z−\hat{z}).

6. Update error covariance: P←(I−KH)P⁻.

7. Determine the linear transition matrix Φ by solving the matrix ODE's (i.e., the so-called Riccati equations):

$$\dot{Φ} = \frac{ⅆ f}{ⅆ x} {\vert}_{\hat{x}} Φ ,$$

with Φ(t=kΔt)=I, on the time interval from kΔt to (k+1)Δt. In this example, the analytic Jacobian of the process model was used.

8. Predict the state for the next epoch by integrating the deterministic process equations:

$${\hat{x}}^{-} ← \hat{x} + {\int }_{k Δ t}^{( k + 1 ) Δ t} f ( t , x ( t ) ) ⅆ t .$$

9. Update the process noise covariance matrix Q, as described previously.

10. Update the covariance matrix: P⁻←ΦPΦ^{T}+Q.

These steps are then repeated for each time-step or epoch. See generally J. L. LeMay & W. L Brogan, “Applications of Kalman Filter Theory: An Extended Kalman Filter Example,” Kalman Filtering, pp. 32-48 (St. Joseph Sciences Inc. 1984).

Analysis of Results

The results for eight (8) datasets are summarized below in Tables 2 through 5.

TABLE 2
Mean Initial Parameter Values.

| Dataset | Vₘ | kₘ | Vₕ | kₕ | τₘ₀ | τₕ | V_{τ} | k_{τ} |
|---|---|---|---|---|---|---|---|---|
| 1 | −30.51 | 10.41 | −55.02 | 5.03 | 10.22 | 15.10 | −59.66 | 21.99 |
| 2 | −30.80 | 10.40 | −59.90 | 4.88 | 9.82 | 15.00 | −61.25 | 22.66 |
| 3 | −30.17 | 10.74 | −57.75 | 5.04 | 9.63 | 14.56 | −58.52 | 22.83 |
| 4 | −29.60 | 11.27 | −57.72 | 4.92 | 9.68 | 14.41 | −58.36 | 21.89 |
| 5 | −29.72 | 10.69 | −58.30 | 5.17 | 9.66 | 15.45 | −60.49 | 22.07 |
| 6 | −30.77 | 10.52 | −56.78 | 4.77 | 9.44 | 15.04 | −60.14 | 21.96 |
| 7 | −31.07 | 10.31 | −57.29 | 5.04 | 10.35 | 14.03 | −59.34 | 21.55 |
| 8 | −30.73 | 10.43 | −58.05 | 5.09 | 9.88 | 15.58 | −61.62 | 21.50 |
| Grand | −30.42 | 10.60 | −57.60 | 4.99 | 9.84 | 14.90 | −59.92 | 22.06 |
| mean | | | | | | | | |

TABLE 3
Standard Deviations of Initial Parameter Values.

| Dataset | Vₘ | kₘ | Vₕ | kₕ | τₘ₀ | τₕ | V_{τ} | k_{τ} |
|---|---|---|---|---|---|---|---|---|
| 1 | 3.12 | 1.23 | 6.38 | 0.56 | 0.93 | 1.83 | 6.77 | 2.09 |
| 2 | 3.15 | 1.24 | 6.46 | 0.62 | 0.96 | 1.47 | 6.43 | 2.59 |
| 3 | 3.75 | 1.08 | 5.96 | 0.63 | 1.21 | 1.53 | 5.67 | 3.01 |
| 4 | 3.75 | 1.09 | 5.54 | 0.59 | 1.09 | 2.04 | 6.55 | 2.54 |
| 5 | 4.02 | 1.07 | 6.24 | 0.51 | 1.06 | 1.68 | 6.67 | 2.93 |
| 6 | 3.97 | 1.32 | 7.52 | 0.61 | 1.12 | 1.58 | 8.20 | 3.26 |
| 7 | 3.32 | 1.13 | 6.60 | 0.55 | 1.07 | 1.56 | 7.68 | 2.21 |
| 8 | 3.65 | 1.18 | 6.53 | 0.57 | 1.22 | 1.74 | 7.51 | 2.70 |
| Grand | 3.59 | 1.17 | 6.40 | 0.58 | 1.08 | 1.68 | 6.94 | 2.67 |
| mean | | | | | | | | |

TABLE 4
Mean Final Parameter Values.

| Dataset | Vₘ | kₘ | Vₕ | kₕ | τₘ₀ | τₕ | V_{τ} | k_{τ} |
|---|---|---|---|---|---|---|---|---|
| 1 | −30.92 | 10.54 | −56.47 | 4.69 | 9.80 | 14.62 | −59.35 | 22.31 |
| 2 | −30.75 | 10.58 | −55.87 | 4.90 | 10.26 | 14.99 | −59.79 | 21.84 |
| 3 | −30.13 | 10.32 | −56.00 | 4.75 | 9.90 | 14.98 | −59.91 | 21.81 |
| 4 | −30.45 | 10.32 | −57.32 | 4.89 | 9.66 | 14.60 | −59.37 | 22.13 |
| 5 | −29.94 | 10.73 | −56.18 | 4.99 | 9.24 | 15.05 | −60.54 | 22.57 |
| 6 | −30.02 | 10.63 | −54.89 | 4.50 | 9.82 | 14.88 | −59.80 | 22.14 |
| 7 | −29.80 | 10.65 | −55.63 | 4.69 | 9.89 | 14.93 | −60.03 | 21.88 |
| 8 | −30.08 | 10.33 | −56.45 | 4.91 | 9.04 | 15.37 | −60.64 | 22.77 |
| Grand | −30.26 | 10.51 | −56.10 | 4.79 | 9.70 | 14.93 | −59.93 | 22.18 |
| mean | | | | | | | | |

TABLE 5
Standard Deviations of Final Parameter Values.

| Dataset | Vₘ | kₘ | Vₕ | kₕ | τₘ₀ | τₕ | V_{τ} | k_{τ} |
|---|---|---|---|---|---|---|---|---|
| 1 | 0.18 | 0.14 | 1.71 | 0.42 | 0.48 | 0.08 | 0.49 | 0.65 |
| 2 | 0.21 | 0.21 | 2.61 | 0.61 | 0.60 | 0.10 | 0.40 | 0.71 |
| 3 | 0.15 | 0.13 | 1.19 | 0.33 | 0.81 | 0.09 | 0.47 | 0.91 |
| 4 | 0.18 | 0.23 | 1.78 | 0.46 | 0.53 | 0.10 | 0.47 | 0.70 |
| 5 | 0.14 | 0.13 | 1.23 | 0.33 | 0.60 | 0.09 | 0.55 | 0.88 |
| 6 | 0.26 | 0.17 | 1.79 | 0.42 | 0.97 | 0.09 | 0.90 | 0.99 |
| 7 | 0.16 | 0.14 | 1.45 | 0.35 | 0.68 | 0.09 | 0.67 | 0.88 |
| 8 | 0.19 | 0.18 | 1.61 | 0.39 | 0.81 | 0.11 | 0.97 | 1.04 |
| Grand | 0.19 | 0.17 | 1.67 | 0.41 | 0.69 | 0.09 | 0.62 | 0.85 |
| mean | | | | | | | | |

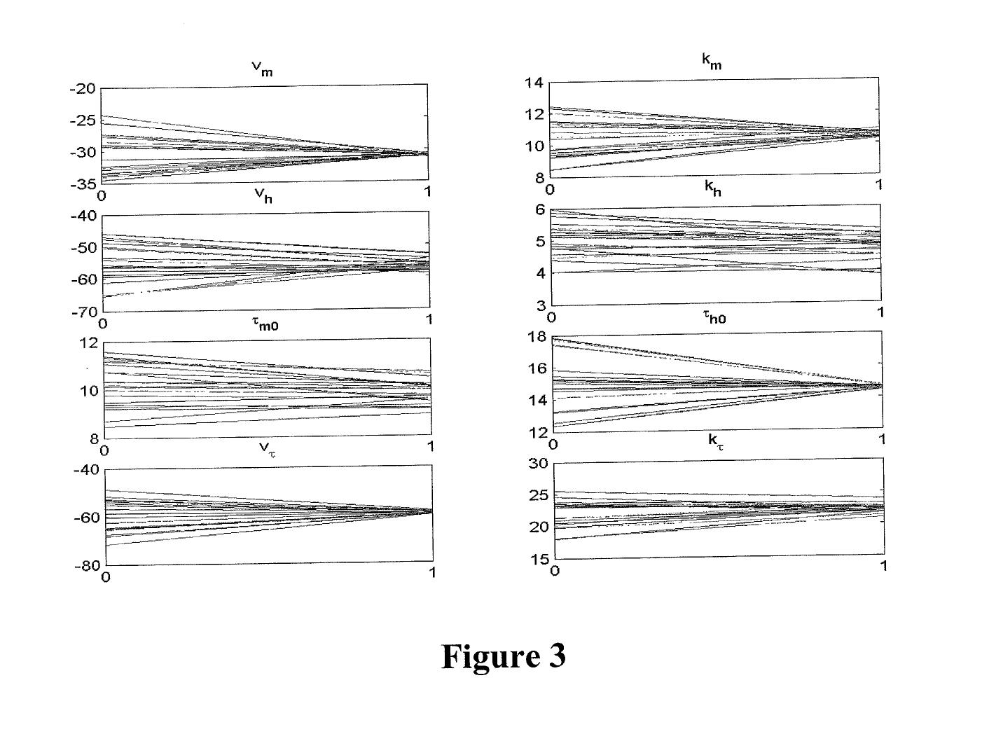

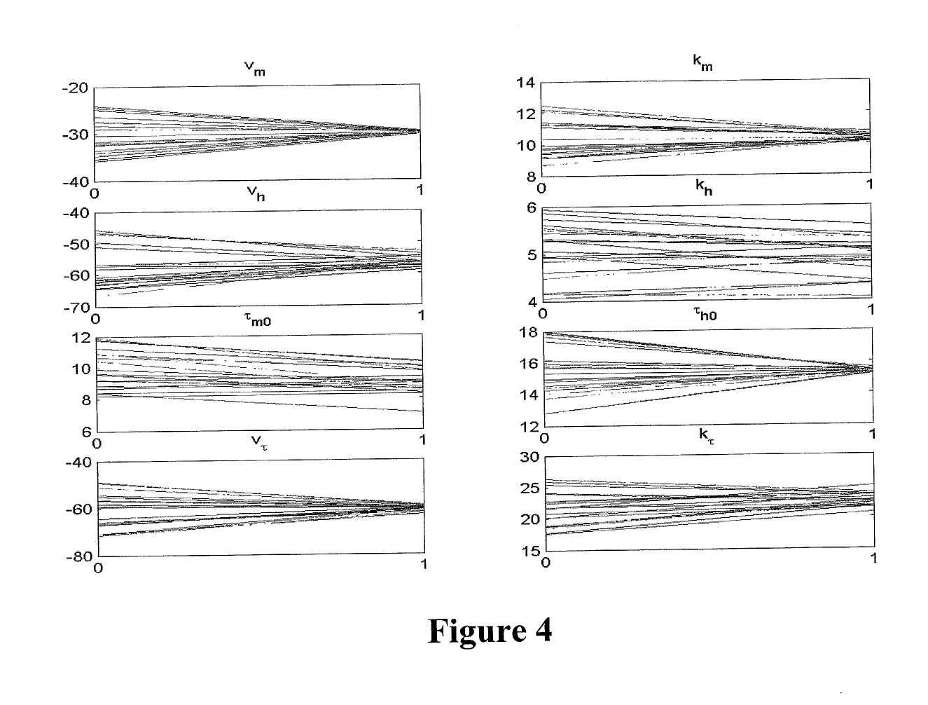

FIGS. 3 and 4 depict the results from two datasets—specifically the results from datasets 1 and 8. For each dataset, the modified EKF method was applied twenty times (using a different set of initial parameter values each time) to a data set generated using Gillespie's method (determining the average behavior of 1000 simulated individual channels). Each figure includes eight subplots—one for each parameter estimated. The subplots each depict the initial and final values for each parameter, with a straight line connecting the initial and final values.

As is readily apparent from the figures, the estimated parameter values converge to the actual parameter value used to generate the pseudo-data for all parameters except for τₘ₀ and kₕ. Possible explanations for the failure to converge include: (1) the observable variable I_{Ca} may not be sensitive to the particular parameter; (2) the parameters may be correlated with each other or with other estimated parameters; and (3) the fading-memory characteristics of the Kalman filter are unsuited for estimating these particular parameters.

The foregoing descriptions of specific embodiments of the present invention are presented for purposes of illustration and description. They are not intended to be exhaustive or to limit the invention to the precise forms disclosed; indeed, many modifications and variations are possible in view of the above teachings. The embodiments were chosen and described in order to explain the principles of the invention and its practical applications, and to thereby enable others skilled in the art to utilize the invention in its various embodiments with various modifications as are best suited to the particular use contemplated. Therefore, while the invention has been described with reference to specific embodiments, the description is illustrative of the invention and is not to be construed as limiting the invention. In fact, various modifications and amplifications may occur to those skilled in the art without departing from the true spirit and scope of the invention as defined by the subjoined claims.

All publications, patents and patent applications mentioned in this specification are herein incorporated by reference to the same extent as if each individual publication or patent application were specifically and individually designated as having been incorporated by reference.

We claim:

1. A method for quantitative or semi-quantitative modeling of a biological or physiological system, said method comprising the steps of:
a. acquiring time-series image data relating to said biological or physiological system;
b. generating a prediction of the dynamic evolution of the state of said biological or physiological system using a simulation model that takes into account underlying physiological, chemical or biological variables;
c. converting said biological- or physiological-state prediction into a series of predicted images corresponding temporally to the acquired images; and
d. modifying the simulation model in such a manner as to reduce the magnitude of an error measure that is based upon the differences between the acquired time-series image data and the predicted images.

2. The method of claim 1 wherein said image data is acquired at regular time intervals.

3. The method of claim 1 wherein said image data is acquired at irregular time intervals.

4. The method of claim 1 wherein said image data comprises raw experimental data.

5. The method of claim 1 wherein said image data comprises processed or transformed data.

6. The method of claim 1 wherein said image data are preprocessed to improve image quality.

7. The method of claim 1 wherein said image data is obtained using an extrinsic probe.

8. The method of claim 1 wherein said image data is obtained using an intrinsic probe.

9. The method of claim 1 wherein said acquired image data includes fluorescence image data.

10. The method of claim 9 wherein said fluorescence image data is obtained using one or more of the following fluorescent probes: Fura-2, GFP or a GFP-variant, fluorescent semiconductor nanocrystals, fluorescein diacetate or chloromethyl fluorescein diacetate, and rhodamine.

11. The method of claim 10 wherein said fluorescent probe comprises GFP, a GFP variant or a GFP fusion protein.

12. The method of claim 11 wherein said fluorescent probe comprises EGFP, BFP, YFP or CYP.

13. The method of claim 1 wherein said acquired image data includes one-dimensional spatial data.

14. The method of claim 1 wherein said acquired image data includes two-dimensional spatial data.

15. The method of claim 1 wherein said acquired image data includes three-dimensional spatial data.

16. The method of claim 1 wherein the image acquisition step includes use of one or more of the following techniques: video microscopy, confocal microscopy, confocal ratio imaging, light/optical microscopy, EPR spectroscopy, optical force microscopy, atomic force microscopy, spectrographic imaging, digital imaging, and fluorescence imaging.

17. The method of claim 16 wherein the image acquisition step comprises the use of fluorescent imaging or fluorescence-resonance energy transfer techniques.

18. The method of claim 1 wherein said acquired image data includes microarray data.

19. The method of claim 18 wherein said microarray data includes spotted array data.

20. The method of claim 18 wherein said microarray data is obtained using gene chip technology.

21. The method of claim 18 wherein said microarray data is obtained using protein chip technology.

22. The method of claim 1 wherein said simulation model is run simultaneously on multiple processors.

23. The method of claim 1 wherein said simulation model comprises a spatial model.

24. The method of claim 1 wherein said simulation model comprises a compartmental model.

25. The method of claim 1 wherein said simulation model comprises a set of partial differential equations solvable by a numerical PDE solver.

26. The method of claim 1 wherein said simulation model comprises a finite-element model or a finite-difference model.

27. The method of claim 1 wherein said simulation model is solved using a machine learning algorithm

28. The method of claim 1 wherein said error measure is a vector norm or an operator norm.

29. The method of claim 1 wherein said model modification step includes application of a machine-learning algorithm.

30. The method of claim 1 wherein said model modification step includes application of a simulated annealing algorithm.

31. The method of claim 1 wherein said model modification step includes application of a neural network algorithm.

32. The method of claim 31 wherein said neural network algorithm uses a multi-layer perceptron model.

33. The method of claim 31 wherein said neural network algorithm uses a recurrent neural network model.

34. The method of claim 33 wherein said recurrent neural network model is an Elman neural network model.

35. The method of claim 31 wherein said model modification step includes application of a self-organizing map.

36. The method of claim 1 wherein said model modification step comprises adjusting one or more parameters of the said simulation model.

37. The method of claim 1 wherein said model modification step comprises directly modifying the predicted state space vector.

38. The method of claim 1 wherein said model modification step comprises the step of applying a batch estimator.

39. The method of claim 1 wherein said model modification step comprises the step of applying a recursive filter.

40. The method of claim 39 wherein said recursive filter is selected from the group of filters consisting of the least-squares filter, the pseudo-inverse filter, the square-root filter, the Kalman filter, the particle filter, and Jazwinski's adaptive filter.

41. The method of claim 39 wherein said filter is a fading-memory filter.

42. The method of claim 41 wherein said filter is a Kalman-type filter.

43. The method of claim 42 wherein said filter is an extended Kalman filter or an unscented Kalman filter.

44. A method for quantitative or semi-quantitative modeling of a biological or physiological system, said method comprising the steps of:
a. acquiring time-series image data relating to said biological or physiological system;
b. generating a prediction of the dynamic evolution of the state of said biological or physiological system using a simulation model that takes into account underlying physiological, chemical or biological variables;
c. converting said image data into state-space data; and
d. adjusting one or more parameters of the simulation model in order to reduce the magnitude of an error measure that is based upon the differences between the acquired state-space data and the corresponding predicted state(s) of the system.

45. The method of claim 44 wherein said image data is acquired at regular time intervals.

46. The method of claim 44 wherein said image data is acquired at irregular time intervals.

47. The method of claim 44 wherein said image data comprises raw experimental data.

48. The method of claim 44 wherein said image data comprises processed or transformed data.

49. The method of claim 44 wherein said image data are preprocessed to improve image quality.

50. The method of claim 44 wherein said image data is obtained using an extrinsic probe.

51. The method of claim 44 wherein said image data is obtained using an intrinsic probe.

52. The method of claim 44 wherein said acquired image data includes fluorescence image data.

53. The method of claim 44 wherein said fluorescence image data is obtained using one or more of the following fluorescent probes: Fura-2, GFP or a GFP-variant, fluorescent semiconductor nanocrystals, fluorescein diacetate or chloromethyl fluorescein diacetate, and rhodamine.

54. The method of claim 53 wherein said fluorescent probe comprises GFP, a GFP variant or a GFP fusion protein.

55. The method of claim 54 wherein said fluorescent probe comprises EGFP, BFP, YFP or CYP.

56. The method of claim 44 wherein said acquired image data includes one-dimensional spatial data.

57. The method of claim 44 wherein said acquired image data includes two-dimensional spatial data.

58. The method of claim 44 wherein said acquired image data includes three-dimensional spatial data.

59. The method of claim 44 wherein the image acquisition step includes use of one or more of the following techniques: video microscopy, confocal microscopy, confocal ratio imaging, light/optical microscopy, EPR spectroscopy, optical force microscopy, atomic force microscopy, spectrographic imaging, digital imaging, and fluorescence imaging.

60. The method of claim 44 wherein the image acquisition step comprises the use of fluorescent imaging or fluorescence-resonance energy transfer techniques.

61. The method of claim 44 wherein said acquired image data includes microarray data.

62. The method of claim 61 wherein said microarray data includes spotted array data.

63. The method of claim 62 wherein said microarray data is obtained using gene chip technology.

64. The method of claim 62 wherein said microarray data is obtained using protein chip technology.

65. The method of claim 44 wherein said simulation model is run simultaneously on multiple processors.

66. The method of claim 44 wherein said simulation model comprises a spatial model.

67. The method of claim 44 wherein said simulation model comprises a compartmental model.

68. The method of claim 44 wherein said simulation model comprises a set of partial differential equations solvable by a numerical PDE solver.

69. The method of claim 44 wherein said simulation model comprises a finite-element model or a finite-difference model.

70. The method of claim 44 wherein said simulation model is solved using a machine learning algorithm

71. The method of claim 44 wherein said error measure is a vector norm or an operator norm.

72. The method of claim 44 wherein said model modification step includes application of a machine-learning algorithm.

73. The method of claim 44 wherein said model modification step includes application of a simulated annealing algorithm.

74. The method of claim 44 wherein said model modification step includes application of a neural network algorithm.

75. The method of claim 74 wherein said neural network algorithm uses a multi-layer perceptron model.

76. The method of claim 74 wherein said neural network algorithm uses a recurrent neural network model.

77. The method of claim 76 wherein said recurrent neural network model is an Elman neural network model.

78. The method of claim 74 wherein said model modification step includes application of a self-organizing map.

79. The method of claim 44 wherein said model modification step comprises adjusting one or more parameters of the said simulation model.

80. The method of claim 44 wherein said model modification step comprises directly modifying the predicted state space vector.

81. The method of claim 44 wherein said model modification step comprises the step of applying a batch estimator.

82. The method of claim 44 wherein said model modification step comprises the step of applying a recursive filter.

83. The method of claim 82 wherein said recursive filter is selected from the group of filters consisting of the least-squares filter, the pseudo-inverse filter, the square-root filter, the Kalman filter, the particle filter, and Jazwinski's adaptive filter.

84. The method of claim 82 wherein said filter is a fading-memory filter.

85. The method of claim 82 wherein said filter is a Kalman-type filter.

86. The method of claim 85 wherein said filter is an extended Kalman filter or an unscented Kalman filter.

87. A system for quantitative or semi-quantitative modeling of a biological or physiological system, said system comprising:
a. a means for acquiring time-series image data relating to said biological or physiological system;
b. a means for generating a prediction of the dynamic evolution of the state of said biological or physiological system using a simulation model that takes into account underlying physiological, chemical or biological variables;
c. a means for converting said biological- or physiological-state prediction into a series of predicted images corresponding temporally to the acquired images; and
d. a means for adjusting one or more parameters of the simulation model in order to reduce the magnitude of an error measure based upon the differences between the acquired time-series image data and the predicted images.

88. A system for quantitative or semi-quantitative modeling of a biological or physiological system, said system comprising:
a. a means for acquiring time-series image data relating to said biological or physiological system;
b. a means for generating a prediction of the dynamic evolution of the state of said biological or physiological system using a simulation model that takes into account underlying physiological, chemical or biological variables;
c. a means for converting said image data into state-space data; and
d. a means for adjusting one or more parameters of the simulation model in order to reduce the magnitude of an error measure that is based upon the differences between the acquired state-space data and the corresponding predicted state(s) of the system.

89. A method for improving the quality of spatiotemporal data relating to a biological or physiological system, said method comprising the steps of:
a. acquiring time-series image data relating to said biological or physiological system;
b. generating a prediction of the dynamic evolution of the state of said biological or physiological system using a simulation model that takes into account underlying physiological, chemical or biological variables; and
c. correcting the acquired images to eliminate noise and measurement errors based upon the predictions of said simulation model.

90. A system for improving the quality of spatiotemporal data relating to a biological or physiological system, said system comprising:
a. a means for acquiring time-series image data relating to said biological or physiological system;
b. a means for generating a prediction of the dynamic evolution of the state of said biological or physiological system using a simulation model that takes into account underlying physiological, chemical or biological variables; and
c. a means for correcting the acquired images to eliminate noise and measurement errors based upon the predictions of said simulation model.

91. A method for quantitative or semi-quantitative modeling of a biological or physiological system, said method comprising the steps of:
a. acquiring time-series fluorescence image data relating to said biological or physiological system;
b. generating a prediction of the dynamic evolution of the state of said biological or physiological system using a simulation model that takes into account underlying physiological, chemical or biological variables;
c. converting said biological- or physiological-state prediction into a series of predicted images corresponding temporally to the acquired images; and
d. applying a batch estimator or recursive filter to the predicted images and the acquired image data.

92. A method for quantitative or semi-quantitative modeling of a biological or physiological system, said method comprising the steps of:
a. acquiring fluorescence image data relating to said biological or physiological system;
b. generating a prediction of the state of said biological or physiological system using a simulation model that takes into account underlying physiological, chemical or biological variables and the acquired fluorescence image data; and
c. converting said biological- or physiological-state prediction into a set of predicted images corresponding to the acquired images.

93. The method of claim 92 wherein said fluorescence image data comprises spatiotemporal data.

94. A method for detecting undamped random disturbances in, and tracking the altered state trajectory of, a biological or physiological system, said method comprising the steps of:
a. acquiring time-series data relating to said biological or physiological system;
b. generating a prediction of the dynamic evolution of the state of said biological or physiological system using a simulation model that takes into account underlying physiological, chemical or biological variables; and
c. applying a recursive memory-fading filter to determine the onset of a symmetry-breaking event.

95. The method of claim 94 wherein said time-series data comprises image data.

96. A method for detecting undamped random disturbances in, and tracking the altered state trajectory of, a biological or physiological system, said system comprising:
a. a means for acquiring time-series data relating to said biological or physiological system;
b. a means for generating a prediction of the dynamic evolution of the state of said biological or physiological system using a simulation model that takes into account underlying physiological, chemical or biological variables; and
c. a recursive fading-memory filter applied to predicted state and acquired data to determine the onset of a symmetry-breaking event.

97. The method of claim 95 wherein said time-series data comprises image data.
